(19) United States
(12) Patent Application Publication
(10) Pub. No.: US 2025/0131289 A1
(43) Pub. Date: Apr. 24, 2025

(54) Knowledge Graph Extraction

(71) Applicant: Microsoft Technology Licensing, LLC, Redmond, WA (US)

(72) Inventors: Jonathan Karl LARSON, Bremerton, WA (US); David Jan KOLECZEK, Southwick, MA (US); Darren Keith EDGE, Cambridge (GB); Thu Ha TRINH, Kirkland, WA (US); Newman CHENG, Reston, VA (US)

(73) Assignee: Microsoft Technology Licensing, LLC, Redmond, WA (US)

(21) Appl. No.: 18/528,634

(22) Filed: Dec. 4, 2023

Related U.S. Application Data
(60) Provisional application No. 63/545,141, filed on Oct. 20, 2023.

(51) Int. Cl. G06N 5/02

(52) U.S. Cl. CPC G06N 5/02

(57) ABSTRACT

This document relates to providing meaningful information relating to a dataset. One example can obtain aggregated summaries and a related knowledge graph. The example can enable local, community, and global retrieval augmented generation utilizing the aggregated summaries and the knowledge graph.

### PRIORITY

This utility patent application claims priority to U.S. Provisional Patent Application 63/545,14, filed on Oct. 20, 2023, which is hereby incorporated by reference in its entirety.

### BACKGROUND

Retrieval augmented generation (RAG) techniques are the cornerstone of grounding LLMs to domain-specific data by performing similarity searches over embeddings stored in vector databases. LLM reasoning frameworks like Chain-of-Thought or ReACT have proven effective in using RAG as a tool to answer multi-hop reasoning questions within a domain.

### SUMMARY

This patent relates to providing meaningful information relating to a dataset. One example can obtain aggregated summaries and a related knowledge graph. The example can enable local, community, and global retrieval augmented generation utilizing the aggregated summaries and the knowledge graph.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1-3 and 19 illustrate example systems that are consistent with some implementations of the present concepts.

FIGS. 5A-7B illustrate example graph results that are consistent with some implementations of the present concepts.

FIGS. 4, 13-18, and 20 illustrate example flowcharts that are consistent with some implementations of the present concepts.

FIGS. 8A-12 show example content generated by the present concepts and comparison content generated by existing techniques that are consistent with some implementations of the present concepts.

### DETAILED DESCRIPTION

The present concepts relate to leveraging generative artificial intelligence (GAI) models, such as large language models (LLM) to provide useful information. Retrieval augmented generation (RAG) techniques are the cornerstone of grounding LLMs to domain-specific data by performing similarity search over embeddings stored in vector databases. LLM reasoning frameworks like Chain-of-Thought or ReACT have proven effective in using RAG as a tool to answer multi-hop reasoning questions within a domain. However, despite the gains from LLM reasoning frameworks armed with RAG, they fail at intricate analytical tasks and are heavily dependent on the user's working knowledge of the dataset to determine what to query. They also fail to provide facilities that can accurately perform aggregate reasoning across complex questions. In unfamiliar and rapidly evolving data sources, the challenge is even greater for the end user.

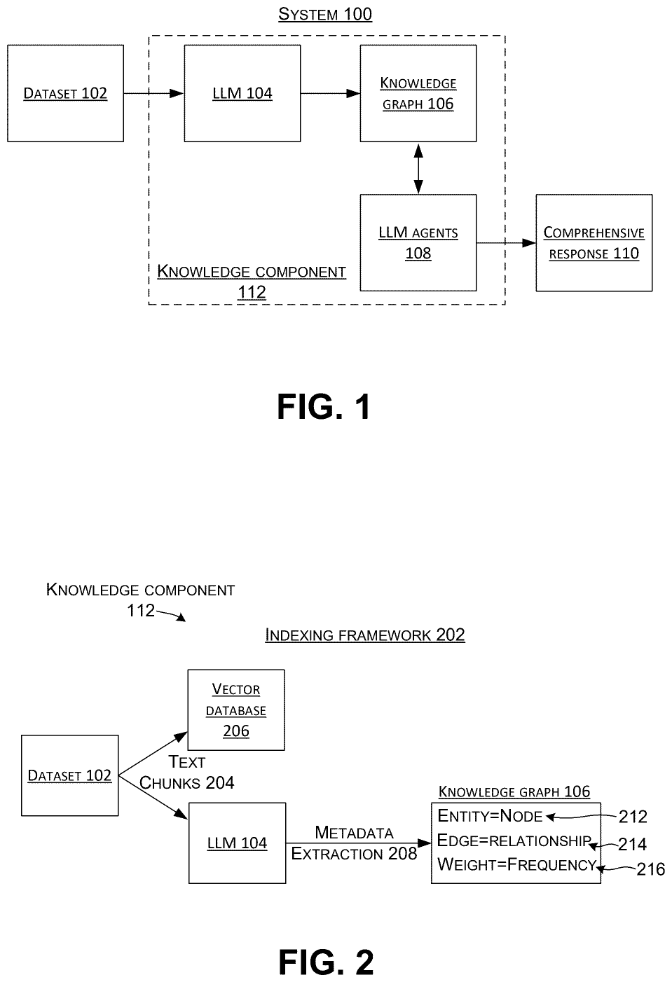

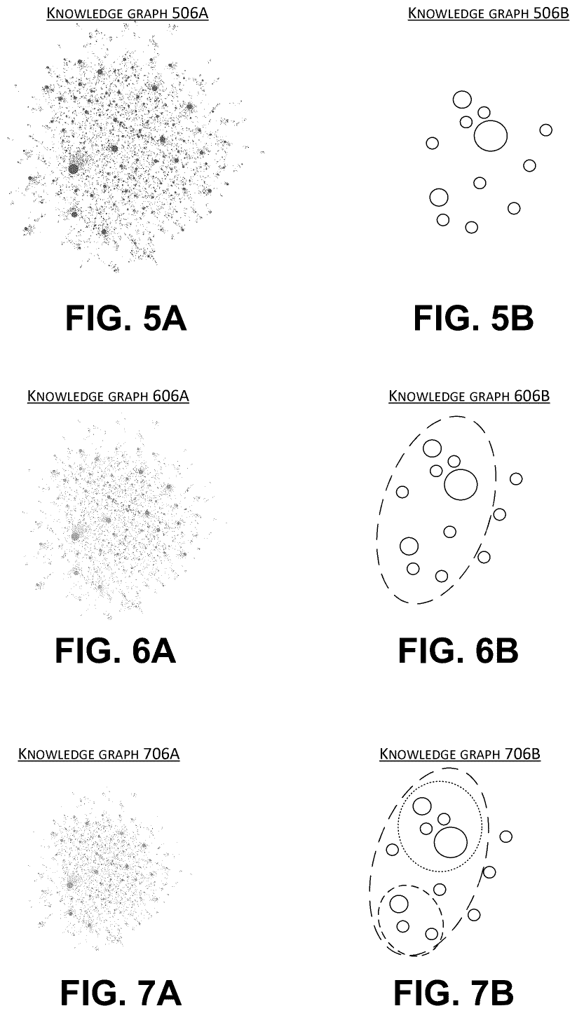

The present concepts address these challenges with technical solutions that include multiple novel aspects. Some of these novel aspects are shown collectively in introductory FIGS. 1-3 relative to an example system 100. This system 100 includes a dataset 102 and leverages an LLM 104 to produce an extracted graph representation or knowledge graph (KG) 106 of the dataset 102. The system also includes graph-based LLM agents (e.g., LLM agents) 108. The LLM 104 extracts and constructs knowledge graph 106 using key relational information stored within the data of the dataset 102. The knowledge graph 106 can be visualized to allow an end user to discover communities at a local and global level, providing easy guidance for an end user to interface with. Example knowledge graph visualizations are described below relative to FIG. 5A-7B.

The LLM agents 108 are able to successfully traverse through the knowledge graph 106 to iteratively formulate a comprehensive response 110 (e.g., a holistic answer for a complex analytical task) while obeying micro and macro level graph structures of the knowledge graph 106. Stated another way, the LLM agents 108 can navigate the extracted knowledge graph 106 to retrieve a more diverse set of documents in order to form the more comprehensive response 110 to the user prompt/question/query. Some or all of these aspects can be overseen and/or coordinated by a knowledge component 112. The knowledge component 112 can also generate user interfaces (UIs) that allow users to access, interact with, and/or receive results from the knowledge graph.

For sake of comparison, an example knowledge graph 106 is induced on the dataset 102. The dataset 102 can be previously unseen by the LLM 104 during training. For example, the dataset 102 can be a private or internally available dataset. For instance, the dataset 102 can be selected from a time period after training the LLMs so that the LLMs do not have innate knowledge of the dataset.

For evaluation purposes, base RAG techniques are compared against the LLM agents 108. Case studies of LLM generated responses show that graph-based LLM agents 108 provide better performance than existing RAG techniques. For instance, the LLM agents 108 can generate more comprehensive responses 110 (e.g., holistic answers) grounded in the dataset 102. More specifically, the LLM agents 108 can navigate the extracted knowledge graph 106 to retrieve a more diverse set of documents in order to form a more comprehensive response 110 to the user. Example comparisons are described below relative to subsequent FIGS., such as FIGS. 8A-8C and 10A-10G.

Existing RAG techniques on grounding data too large to fit a single context window require the use of embeddings at preprocessing and query time to assist the LLM. During the preprocessing phase, the data is chunked, embedded, and stored, often into a persistent vector database for retrieval during query time. At query time, the query is embedded into the same manifold as the preprocessed chunks and is used to search for the nearest neighbors, often using cosine similarity or similar distance computations. The retrieved chunks are added to the original user's query to ground the LLM in relevant information. RAG's fundamental limitations emerge from the known gaps in the information retrieval, particularly temporal relations and nuanced language, as its performance is highly reliant on the data that is retrieved.

Existing construction and utilization of knowledge graphs with LLMs has focused on two aspects, which are disjoint. One side focuses on the LLM's capabilities to correct or impute missing components of an existing knowledge graph, while the other focuses on leveraging the knowledge graph to improve the LLMs reasoning. The contextual ability of fine-tuned LLMs like LLAMA-7B and ChatGLM-6B have been shown to effectively validate and complete/impute missing components of an existing knowledge graph. Alternatively, many of these approaches integrate existing knowledge graphs to augment the LLMs inference and reasoning capabilities. One approach introduces a framework, building on top of CoT and ReACT, that encourages the system to perform discovery and visit nearby nodes and aggregate multiple different paths to work through multi-hop reasoning questions. These knowledge graph paths are fed to the LLM for parsing and boost the reasoning capabilities by modeling unseen or hidden relationships in the data. Similarly, graph construction and traversal over knowledge graphs constructed from multiple documents improves the retrieval of context to the LLM in answering relational questions that span across paragraphs or papers. Finally, early success has also been shown in the prompting of LLMs to extract causal relationships at all layers of the causal hierarchy tree as a formulation of structural learning. While early, this fundamentally reinforces the LLMs innate understanding of nuanced relationships from observational to counterfactual quantities, one that carries forward to knowledge graphs.

One emerging software framework for knowledge graph construction relates to llama-index. This knowledge graph construction method uses an LLM to extract triplets per document chunk to create the relationships. Then at query time, it uses the same construct triplets from the user query to lookup the relevant relationships in the graph. At the present time, it does not have any LLM based enrichment capability, such as entity resolution and summarization. As such, the present concepts are the first to combine both LLM based graph construction and inference allowing the present implementations to surpass the capabilities of RAG for aggregate reasoning.

As mentioned above, evaluation of the present concepts against existing RAG techniques can be more accurate by employing dataset 102 that was not included in training the LLM 104. This can be accomplished through temporal isolation (e.g., using data relating to events that happened after the LLM was trained). In the described example case, the internally available dataset covers the Russian invasion of Ukraine. The invasion occurred after the training of several of the LLMs presently available. In this implementation, the internally available dataset 102 was created by scraping 97,000 news articles from six news providers, interfaxua, mz, ng, nv, ria, and unian on topics regarding the Russian invasion of Ukraine. The collection spanned data from Feb. 24, 2022, the day of the invasion, until Jul. 11, 2023. Due to the recency and majority non-English nature of the collected data, most of the data was likely not present in example LLMs, such as GPT-4's, original training dataset, allowing effective comparison between RAG and the present knowledge graph techniques. Additionally, a major focus of this validation is on data from June 2023, which is mostly beyond when this LLM model (gpt-4-0613) was released. There are some concerns about the relationships the LLM may infer from the 2014 Russian invasion of Crimea, but truly novel events are hard to examine and test.

In relation to FIG. 2, the description now turns to the construction of knowledge graph 106. An indexing framework 202 can be implemented by the knowledge component 112. The indexing framework 202 is employed to enable complex reasoning on large private datasets, such as dataset 102. The indexing framework 202 enables the extraction of key relationship information. First, the indexing framework 202 embeds text chunks 204 to store in a vector database 206, similar to RAG. The indexing framework 202 simultaneously processes the text chunks using the LLM 104 (via metadata extraction 208) into knowledge graph 106. Metadata extraction 208 allows extracting claims, identifying entities of interest 212 and/or establishing relationships 214 between the entities 212. Claims can link to both entities and relationships. These relationships are used in a weighted knowledge graph 106 where each edge's weight value 216 is determined by the frequency of observed occurrence. This is an important distinction to make as pure entity recognition focuses solely on identifying entities. Here, the LLM's assessment of the relationship between entities formulates key knowledge that is derived through a single pass over the data of the dataset 102. Even for entity recognition, the present concepts provide the crucial metadata of an entity summary. This supports future embedding of user questions against embeddings of entity descriptions, not just entity names.

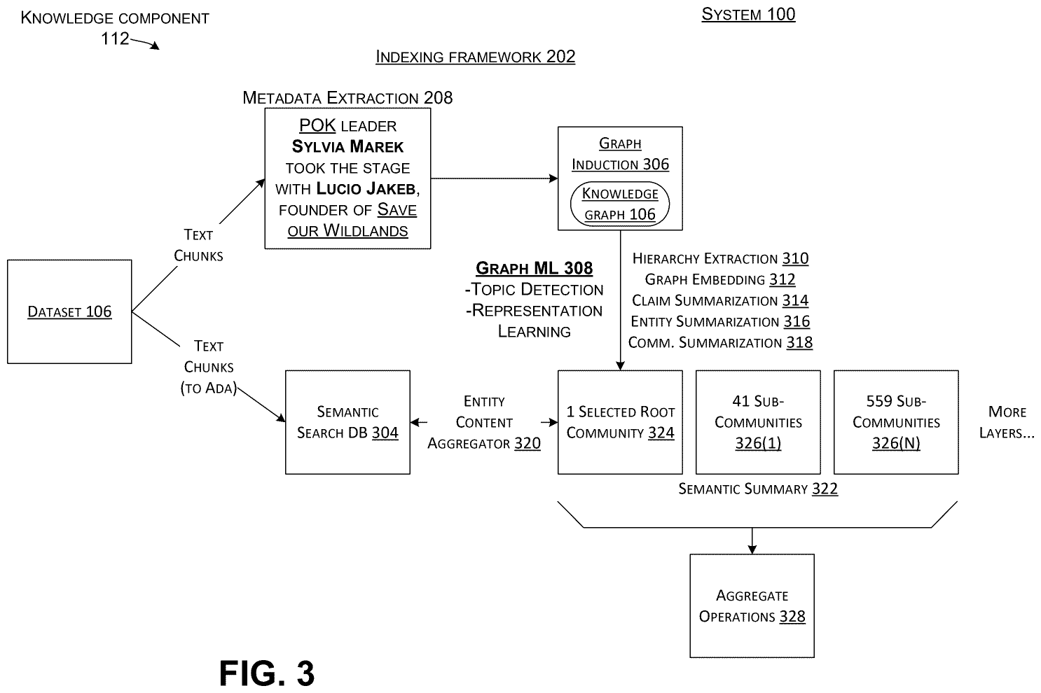

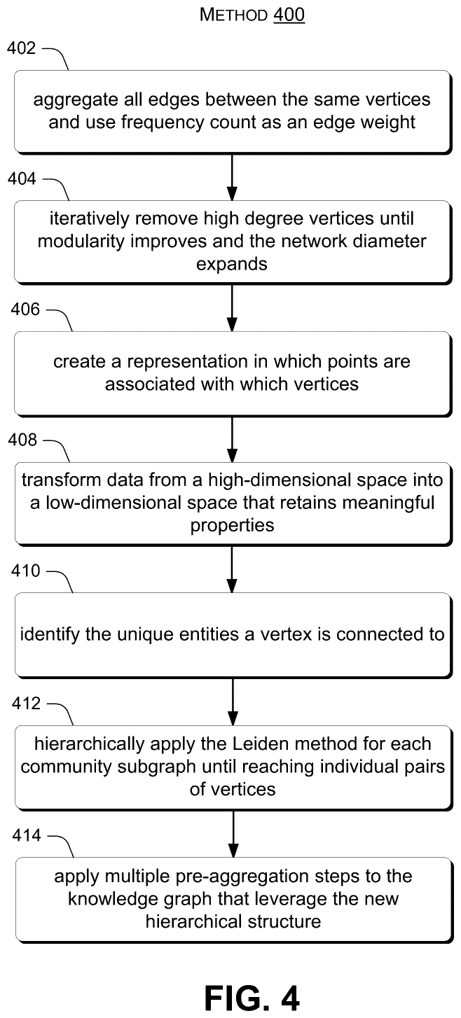

FIG. 3 shows more details relating to processing the dataset 102. This processing can be accomplished by the knowledge component 112, such as with the indexing framework 202. The dataset 102 is too large for adding to a context window. A context window refers to the number of words or tokens the LLM can respond to relative to a prompt. Further, in some scenarios nothing is known by the user about the dataset so a traditional semantic search has limited value. In this case, the text chunks of the dataset 102 can be processed for metadata extraction 208 (e.g., information extraction) and can be processed to produce a semantic search database 304.

The metadata extraction 208 can identify entities in the dataset 102 (e.g., in the data chunks) and relationships between the entities. The metadata extraction also extracts claims using a subject-action-object structure. This is more valuable than relying on co-occurrence, which inter-relates all of the entities and creates large amounts of noise in a resultant knowledge graph. Thus, in the illustrated example of metadata extraction 208, the process identifies entities in the dataset 102 as POK, Sylvia Marek, Lucio Jakeb, and Save Our Wildlands. However, the information extraction identifies relationships between POK and Sylvia Marek and POK and Lucio Jakeb, but not between POK and Save Our Wildlands. The entities and their relationships can be utilized for knowledge graph induction 306 (e.g., producing knowledge graph 106 that represents the entities as nodes/vertices and their relationships as edges).

The knowledge graph 106 can then be processed utilizing graph machine learning 308 for topic detection and/or machine learning. For instance, this can relate to hierarchy extraction 310, graph embedding 312, claim summarization 314, entity summarization 316, and/or community summarization 318.

An entity content aggregator 320 can combine entity content from the semantic search database 304 with the results of the graph induction 306 to produce a semantic summary 322. For instance, the semantic summary 322 can involve a hierarchical set partition structure including one or more selected root communities 324 and various sub-communities 326(1)-326(N). The root communities 324 and the sub-communities 326(1)-326(N) can progress in depth all the way down to the node level if desired. The hierarchical set partition structure functions as an aggregation structure that LLMs can utilize to perform aggregate operations 328. Aggregate operations are operations that are performed on the whole of a data structure, such as an array, rather than performed on an individual element. Examples of aggregate operations include dataset question generation, aggregate summarization, global query interrogation, etc.

Aggregate summarization can entail taking individual observations and grouping them together via some similarity measure such that data can be partitioned based on this similarity. This can be used to then better understand the semantics of particular regions of data when compared to another region of data. Stated another way, the hierarchical structure, summarized recursively from leaves to root such that the summaries always fit within the context window, represent the ‘natural’ aggregate summarization of the dataset in the absence of a user query. In the presence of a user query, the query may be embedded into the space of embedded summaries to work out which novel combinations of summaries need to be summarized to answer the query. Note that in this document the terms “aggregate summarization” and “aggregated summary” are equivalent and are used interchangeably.

FIG. 4 shows a method 400 that some implementations employ on the results of the claim extraction described above. The method includes blocks 402-414.

Block 402 relates to weighted graph induction and aggregates all edges between the same nodes and uses frequency count as an edge weight.

Block 404 relates to graph modularity optimization and filtering. This block iteratively removes high degree nodes until modularity improves and the network diameter expands.

Block 406 relates to graph embedding. The block creates a representation in which points are associated with which nodes. In some cases, node2vec embeddings are used, but many other graph embedding methods could be used including graph neural network and/or spectral approaches, among others.

Block 408 relates to dimensionality reduction to 2D. This block transforms data from a high-dimensional space into a low-dimensional space that retains meaningful properties. One such example is illustrated relative to FIGS. 5A and 5B. Some implementations apply UMAP (uniform manifold approximation and projection), but other dimensionality reduction techniques such as t-sne (T-distributed stochastic neighbor embedding) could be used.

FIG. 5A shows an induced knowledge graph 506A, which is similar to knowledge graph 106 introduced above, for the data described above (e.g., without community detection). FIG. 5B shows a simplified knowledge graph 506B that conveys the concepts represented by knowledge graph 506A.

Returning to method 400, block 410 relates to unweighted degree centrality scaling. The block identifies the unique entities a vertex/node is connected to, which is then used to determine each vertex/node size.

Block 412 relates to graph partitioning. This block hierarchically applies a hierarchical clustering algorithm, such as the Leiden method for each community subgraph until reaching individual pairs of vertices/nodes. At any layer of the hierarchy, a community is defined as a set of vertices which are more connected to each other than they are to the rest of the global graph structure.

FIG. 6A shows a knowledge graph 606A that represents community structure at the root level (e.g., layer 0) via color (e.g., shades of grey on the drawing page). FIG. 6B shows a simplified knowledge graph 606B that conveys the concepts represented by knowledge graph 606A with dashed groupings rather than color.

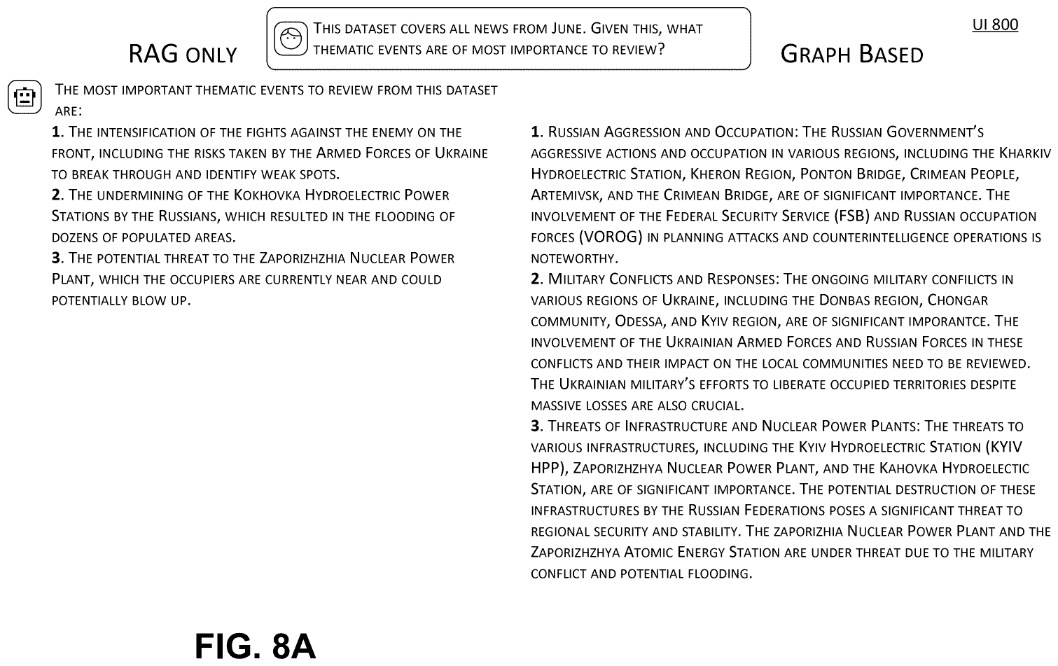

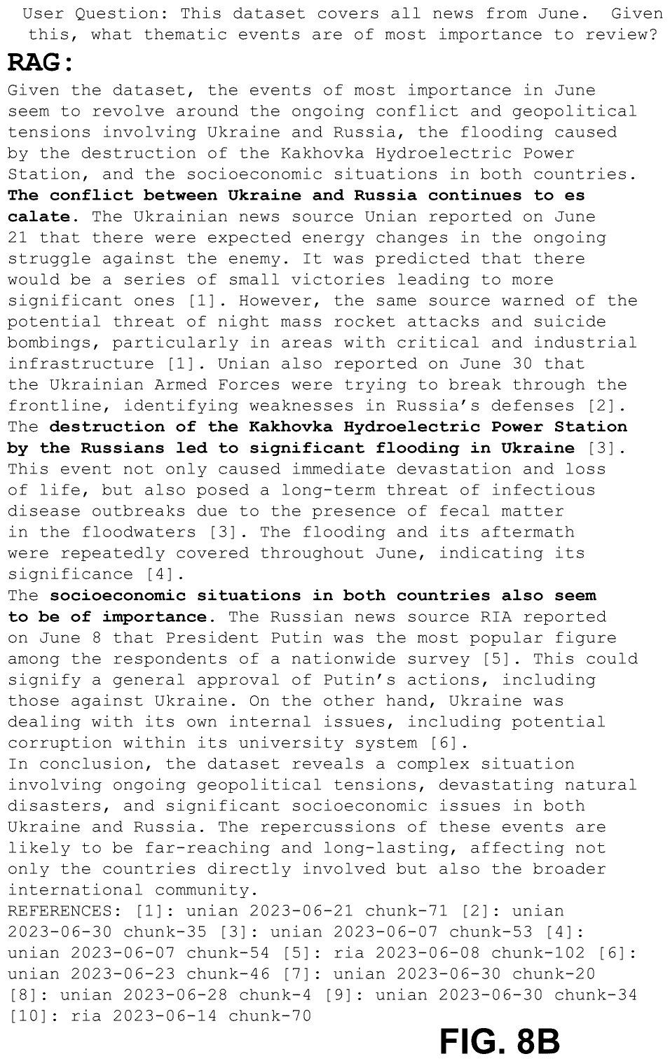

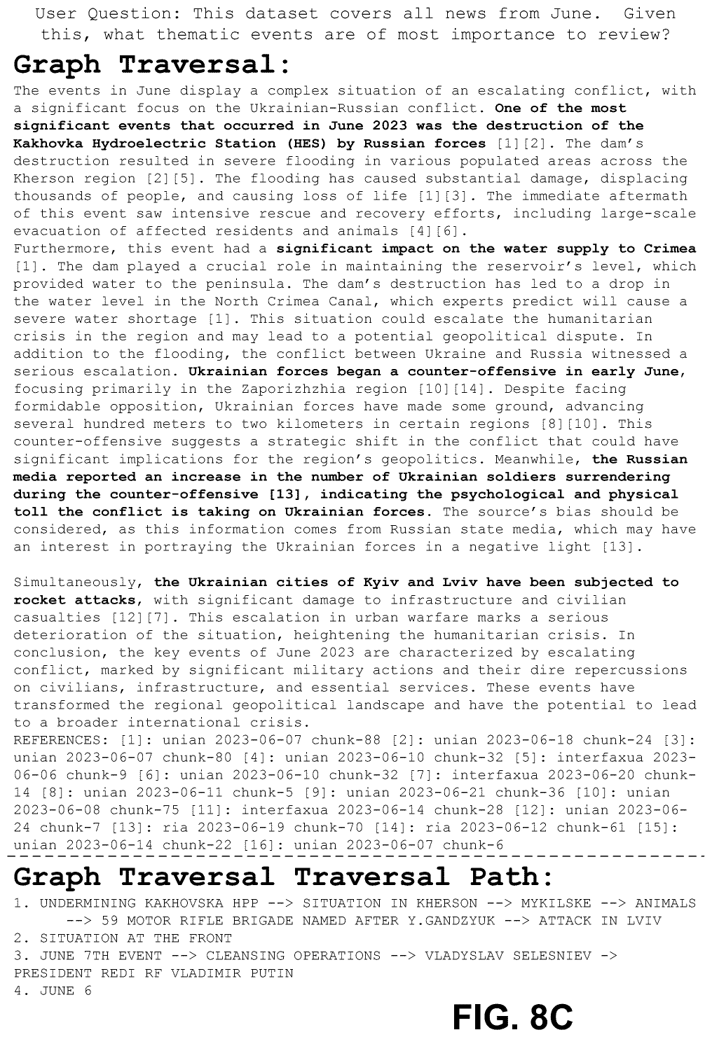

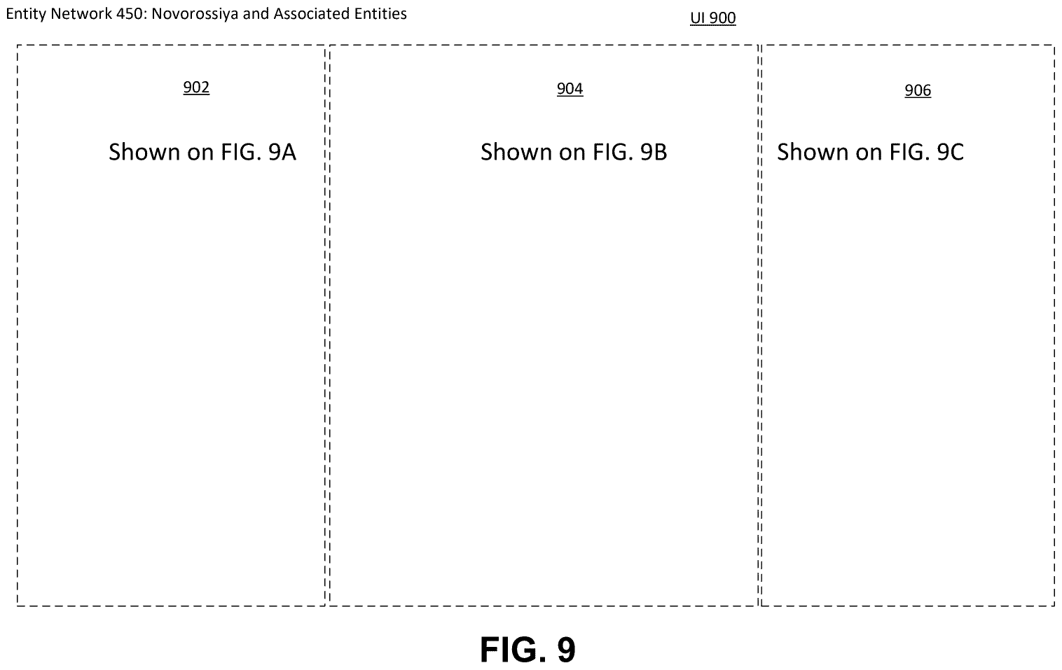

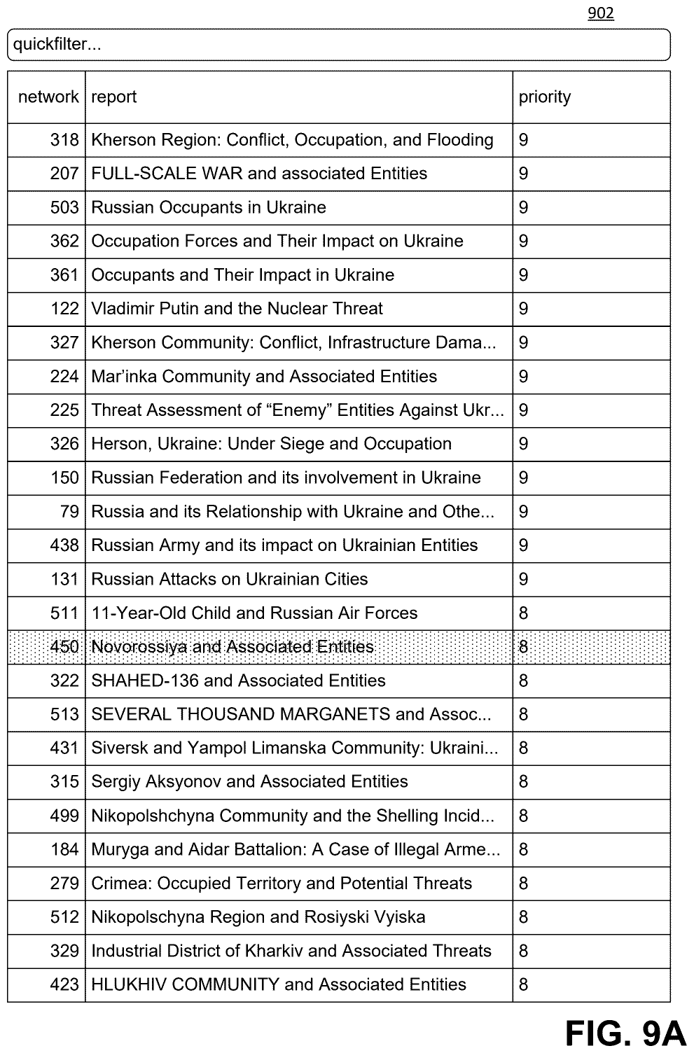

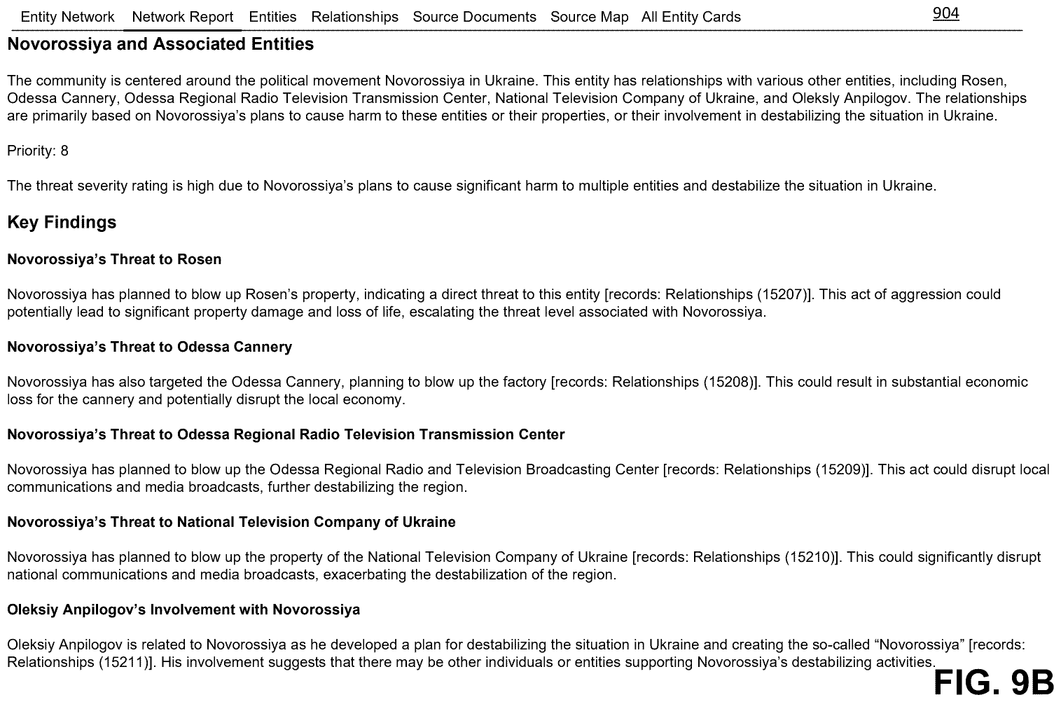

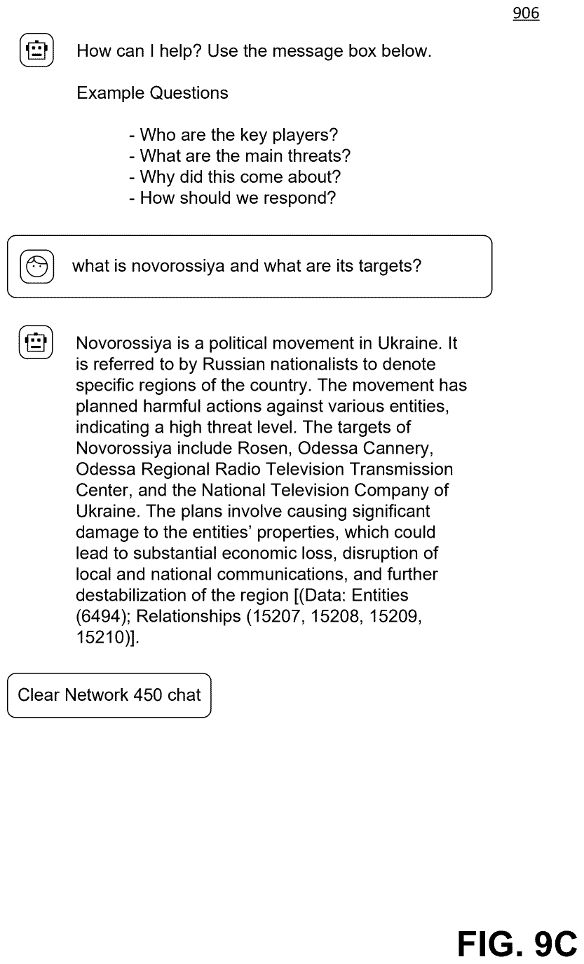

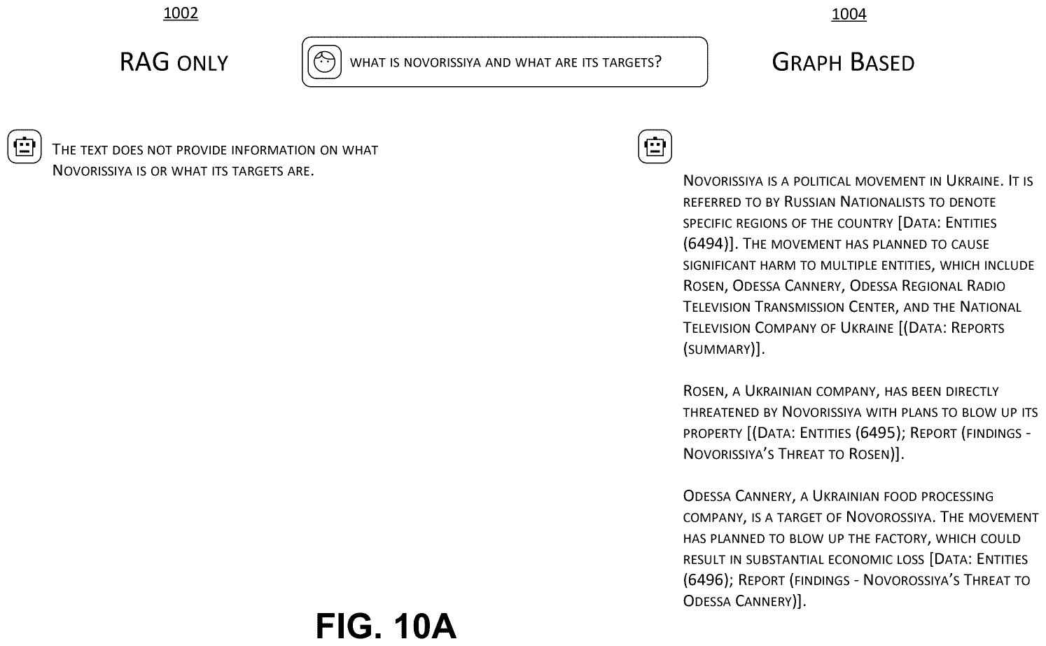

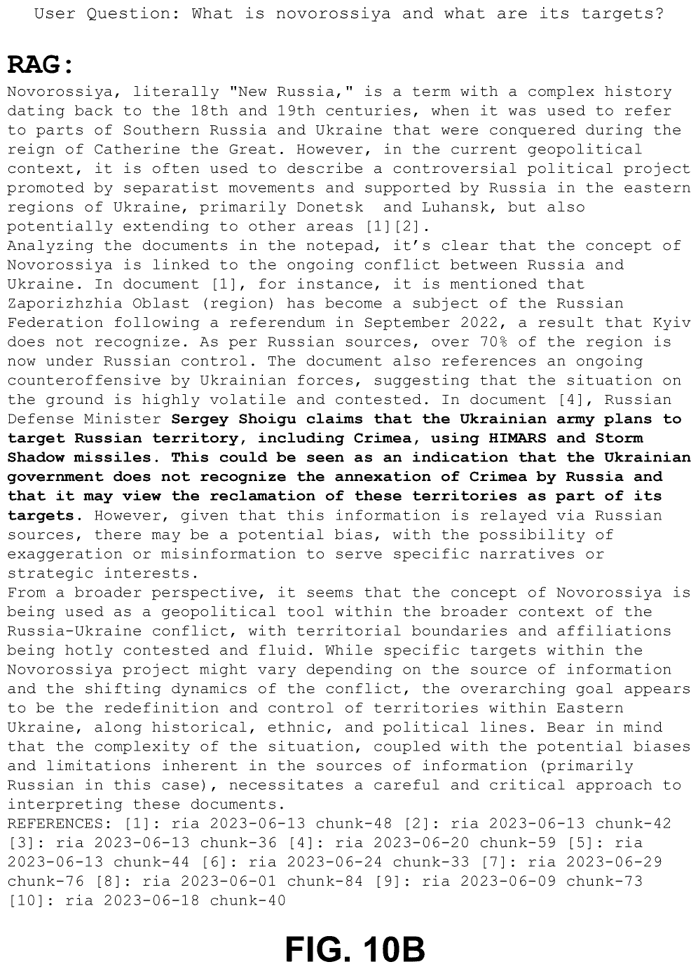

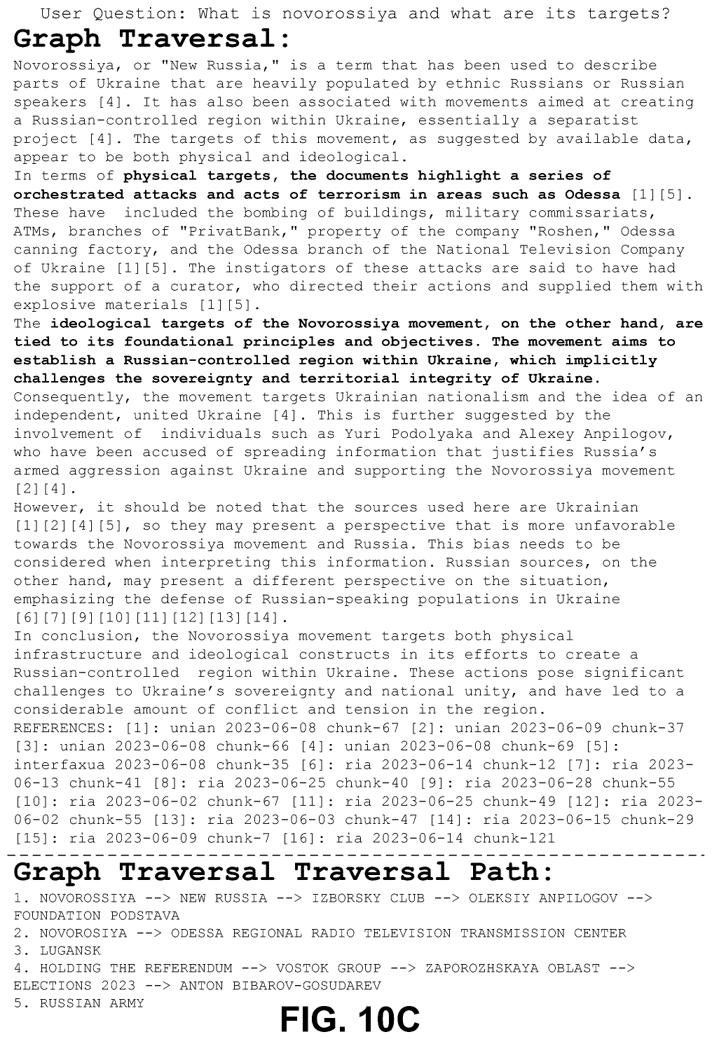

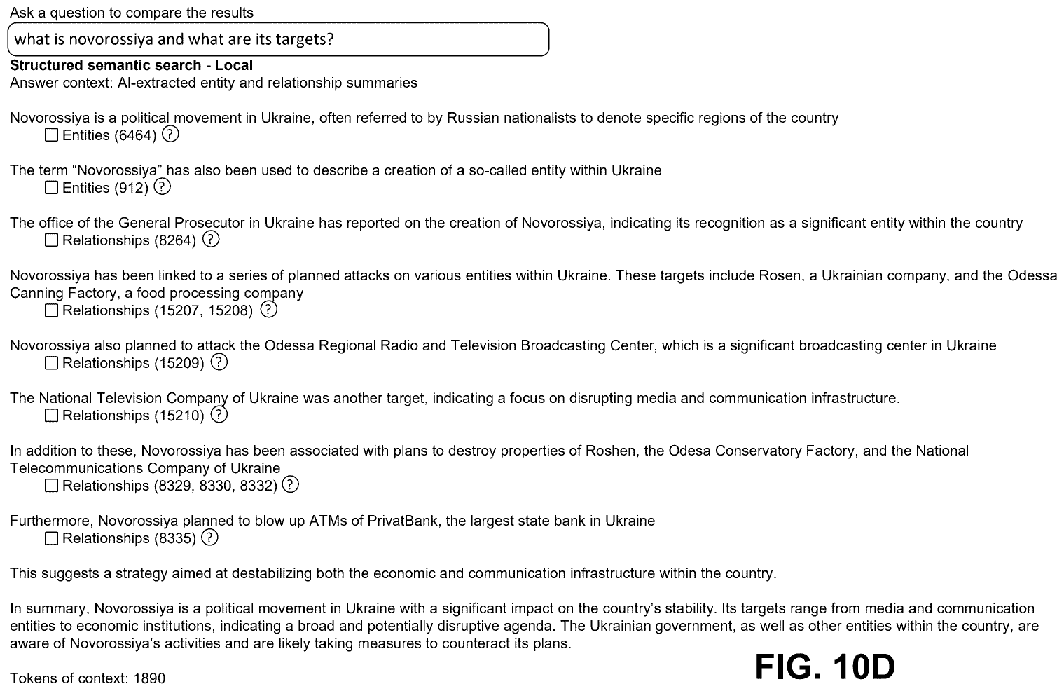

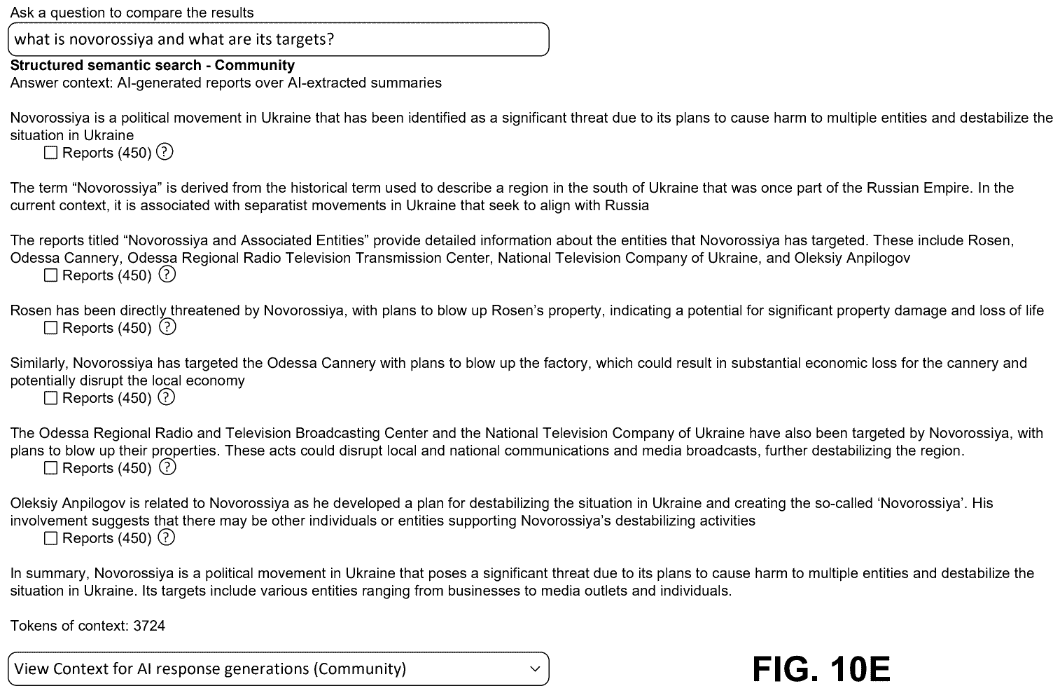

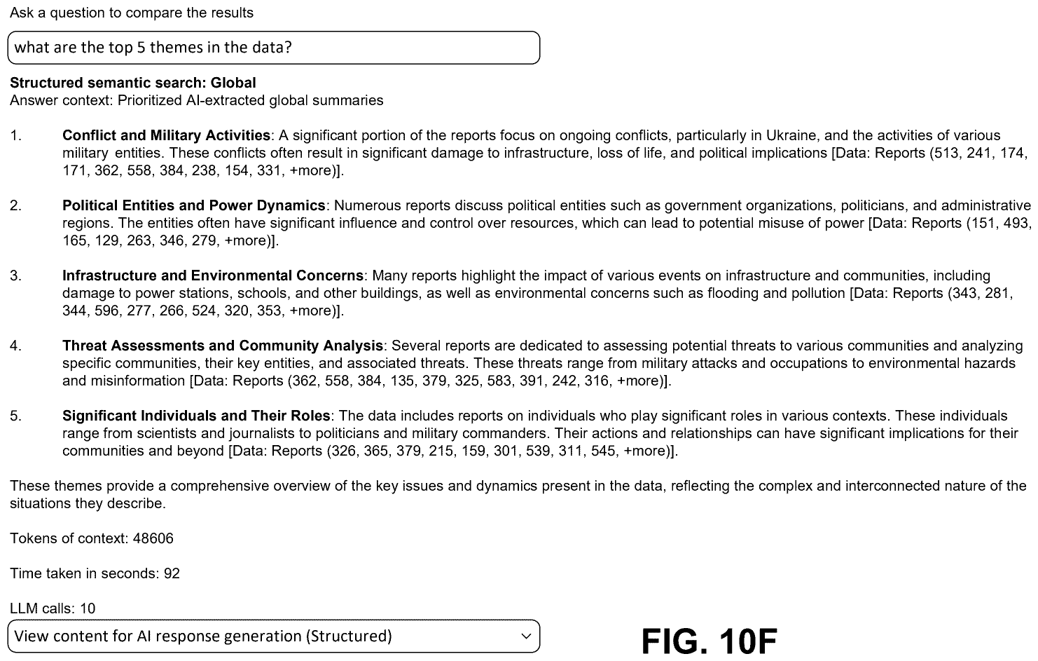

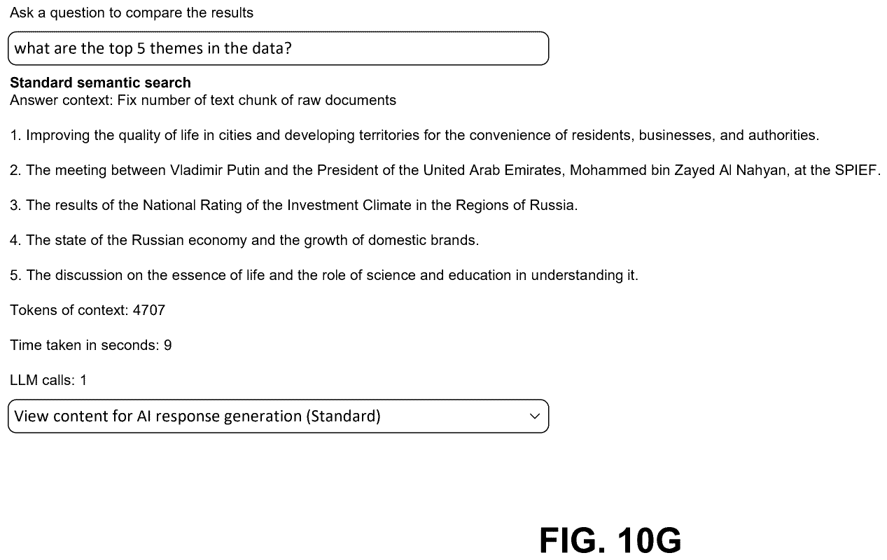

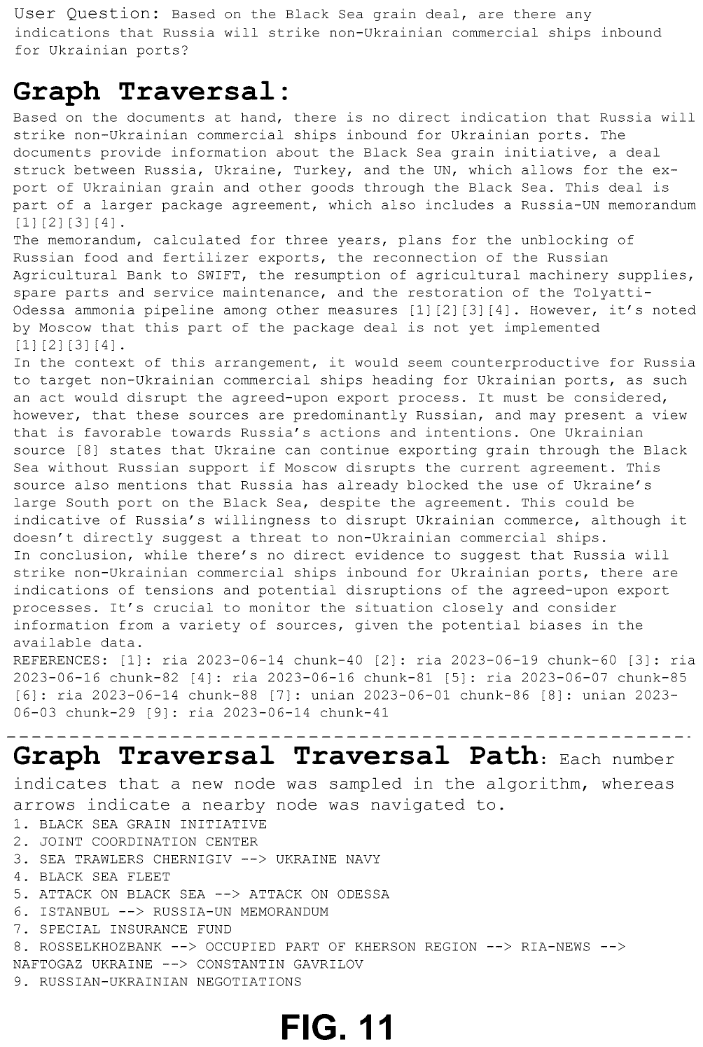

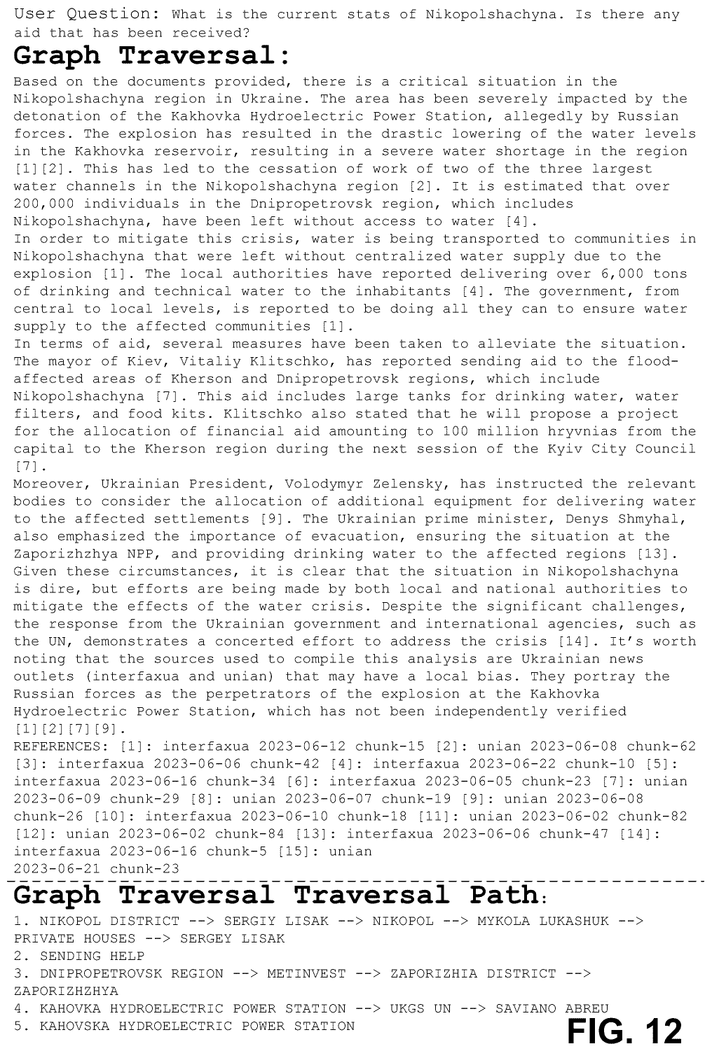

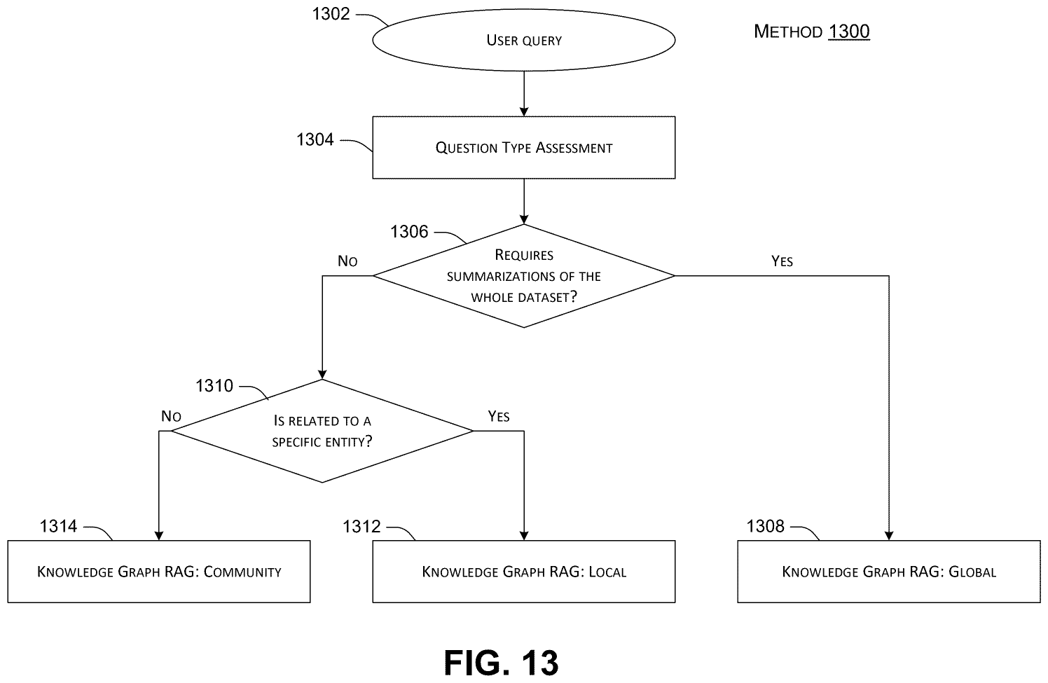

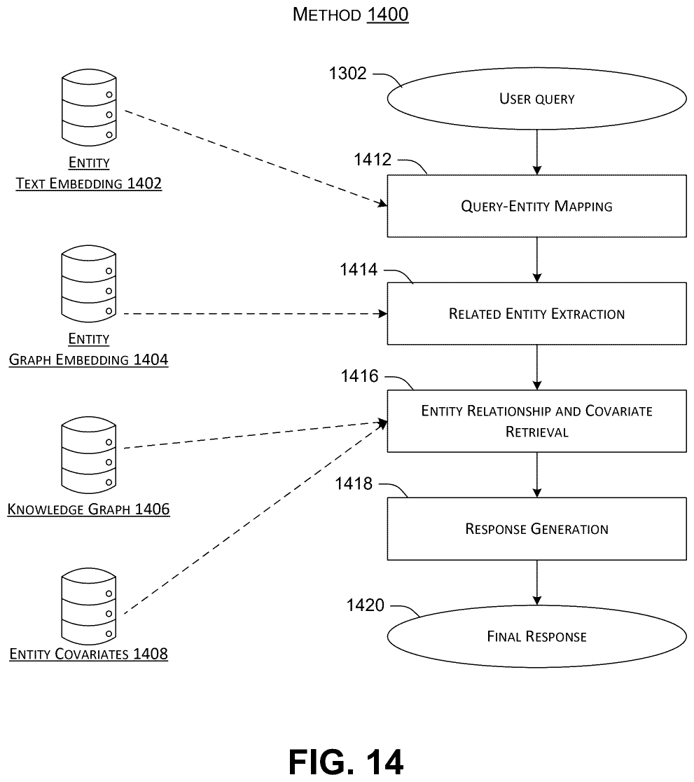

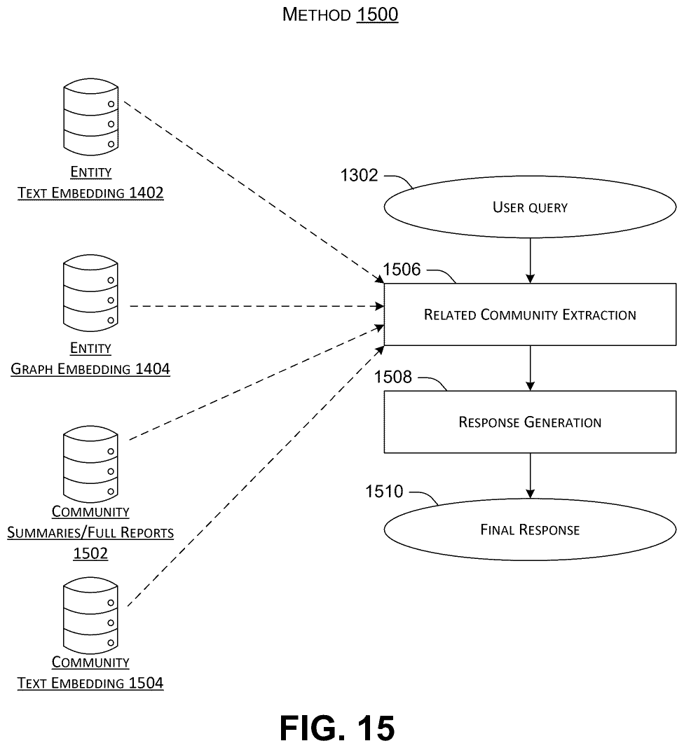

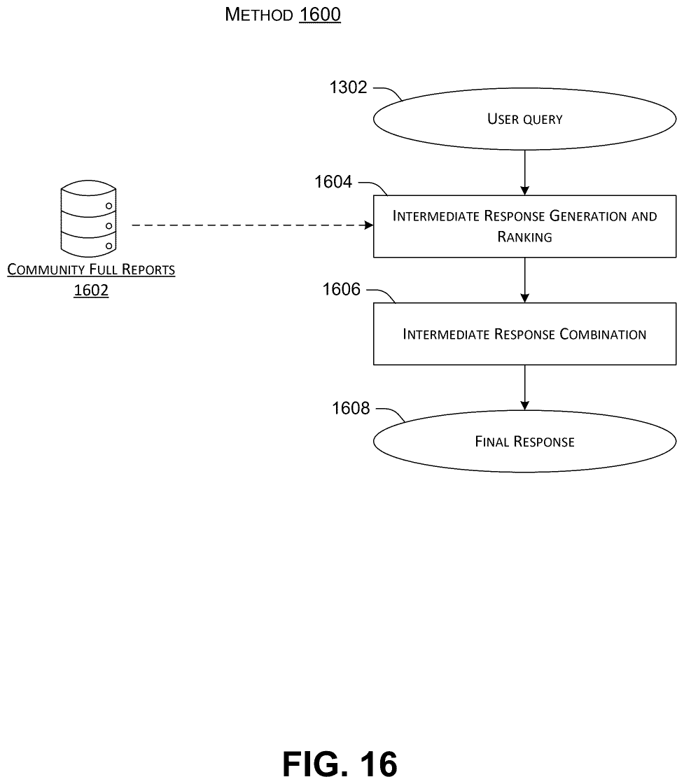

FIG. 7A shows the community structure at a layer 1 of hierarchy, which exhibits many more sub-communities when compared to layer 0 of graphs 606A and 606B. FIG. 7B shows a simplified graph 706B that conveys the concepts represented by graph 706A with dashed groupings rather than color.

To reiterate, FIGS. 5B, 6B, and 7B are employed to convey a simplified form of the concepts of knowledge graphs shown in FIGS. 5A, 6A, and 7A, respectively because the density of nodes and edges of FIGS. 5A, 6A, and 7A cannot effectively be conveyed by line drawings on the drawing page and the color-based relationships of FIGS. 6A and 7A cannot be effectively conveyed on the drawing page.

Returning to method 400, and as explained relative to FIG. 3, once the knowledge graph has been constructed, multiple pre-aggregation steps can be applied that leverage the new hierarchical structure at block 414. Example pre-aggregation steps described relative to FIG. 3 relate to hierarchy extraction 310, graph embedding 312, claim summarization 314, entity summarization 316, and communication summarization 318. Example pre-aggregation steps described below provide additional description relating to entity resolution, entity summarization, community summarization, and community question generation.

Entity resolution can be performed on node/vertices of the knowledge graph. Entities can be duplicated due to variations in phrasing, the source language, or simply typos. These issues can be resolved by translating all entities into a common language (e.g., English in this example) and subsequently asking the LLM, such as GPT-4 to merge similar entities based on supporting community information or the use of LLM text embeddings.

Entity summarization starts with the leaf communities (those deepest in the hierarchy). A summary is generated of each community by analyzing all individual entity summaries within that community. This is recursively performed up the hierarchical tree until reaching the root level communities, which represent large thematic topics. It was discovered that this process is only constrained by the context window. For some implementations to obtain the best summaries, that window should always be optimized to contain the maximal amount of original source material. The roll-up process allows the method to scale to extremely large datasets. In regards to smaller datasets, the method may simply use the raw context chunks directly at the root level when performing summarization. If the context window cannot handle all document chunks within, then the process can fall back to performing summary of summaries starting from the lower communities or entities that are contained within that partition boundary. These community summarizations (FIG. 3, 318) can prove especially powerful as they provide a unique aggregated viewpoint into the data, a clear differentiator over RAG.

Finally, using the community summarizations (FIG. 3, 318), the LLM, such as GPT-4 can be utilized to analyze all top-level communities and subsequently generate motivating questions of interest. Similarly, this can be used to help support high-level or aggregate reasoning, questions, such as “What are the major themes to investigate?”. Examples of this can be seen in FIGS. 8A-8C, which show user interfaces (UIs) 800 relating to examining an open-ended analytical question that must be inferred. In this example the open-ended analytical question entails a user question stating “This dataset covers all news from June. Given this, what thematic events are of most importance to review?” FIG. 8A shows an abridged side-by-side comparison. A RAG response is shown on FIG. 8B and a graph traversal response consistent with the present concepts is shown on the FIG. 8C.

FIG. 8A shows side-by-side comparisons of RAG and graph-based results. RAG performed a nearest neighbor search on “This dataset covers all news from June. Given this, what thematic events are of most importance to review?” This is a summarization task for which the RAG has no context, so it ultimately sampled a bunch of somewhat random documents and then summarized them. The graph-based approach used the generated graph structure and its summaries to ask the same question on the whole-dataset summarization that the graph generated. This gives it full context and results in a far more comprehensive outcome.

FIG. 8B shows a RAG response for comparison to the graph-based approach of FIG. 8C. The graph traversal shown on FIG. 8C was able to retrieve context about more relevant events and broad topics of interest. The Kakhovka Dam (which both methods retrieve), but graph traversal also provides details about its humanitarian impact, the Ukrainian counteroffensive, the Russian perspective on the counteroffensive, and attacks on Kyiv and Lviv. This is subjective, but the RAG response discusses socioeconomic events that do not seem relevant to only June.

The present concepts provide a technical solution that can augment traditional RAG approaches using the constructed knowledge graphs by retrieving relevant graph assets within a discovered community to help derive answers to analytic questions (e.g., community-based RAG). This addresses a key limitation of RAG. RAG works best when a user queries on key concepts that exist within the dataset. So, for RAG to work well, the user is assumed to have some notion about what they are looking for ahead of time. However, this can prove very difficult in unseen and/or dynamic datasets as users may lack an understanding of what is in the dataset. To this end, the visualization of graph structures significantly closes this gap by enabling discovery. Interactive community exploration tools were built and deployed that use the inferred community hierarchy to drive exploration. This is paired with LLM (e.g., GPT-4) based priority scoring functions that are used to rank communities based on their potential relevance.

In these interactive community exploration tools, users can use communities as anchors from which to provide better context for RAG. For example, beginning with the query “What is Novorossiya?”, the user can select the community containing the entity Novorossiya. Identifying this community, RAG can now benefit from the community's pre-aggregated report and all entities and relationships within that community. All of this can be provided as additional context to the RAG operation and improve the result, or by automating the discovery process with graph traversals.

FIGS. 9-9C show a novel user interface (UI) 900 that can be generated by the knowledge component 112 of FIG. 1. The UI 900 relates to the user query or question “What is Novorossiya and what are its targets?”. The UI is built to allow discovery on derived communities-selecting a community around Novorossiya. The left panel 902 shows prioritization of communities based on LLM ranking. The middle panel 904 shows a full community report summary that was pre-generated. The right panel 906 shows a query that uses the community information to augment the context when given a RAG style query.

FIGS. 10A-10C show results of another RAG versus Graph Traversal comparison for the example introduced above relative to FIG. 9 relating to the user question “What is Novorossiya and what are its targets?”. FIG. 10A shows an abridged side-by-side comparison of RAG results 1002 and novel graph traversal results 1004. FIG. 10B shows detailed RAG results and FIG. 10C shows detailed novel graph traversal results.

As shown on FIG. 10A, RAG is trying to search on “Novorossiya”, but it is not a super prominent entity in the dataset. Because of the dataset chunk size, that entity apparently got lost in the chunk embeddings such that no relevant information on the topic was returned to the LLM—highlighting a recall problem in RAG.

Novel graph-based approaches can tackle this several ways efficiently. The easiest is simply to parse the query for entities, in which case it will pull out “Novorossiya” as an entity—which also exists in the knowledge graph. Using the knowledge graph as grounding, it retrieves relevant grounding documents and answers the question correctly—including the relationship aspects of the question. For the case shown to the right of FIG. 10A, the “Novorossiya” community is used as grounding context, which produced excellent summaries.

The graph traversal 1004 cites both Ukrainian and Russian perspectives. This UI mentions a specific example in Odessa of a targeted attack as being one of the examples of “targets” of Novorossiya. This can be attributed to all the retrieved documents and references from the Russian news source ria, whereas graph traversal retrieves a diverse set (from three sources).

Novel graph-based LLM agent algorithms can be employed using the aforementioned techniques and graph assets to facilitate GPT-4 guided graph traversal. One example novel graph-based LLM agent algorithm is detailed in Algorithm 1 listed below. Additional example novel graph-based LLM agent algorithms are described relative to FIGS. 13-16.

The novel graph-based LLM agent algorithms provide technical solutions that allow retrieving a richer set of source documents before generating a final response to an open-ended analytical question that requires inference across multiple documents. These concepts provide a technical solution that addresses several limitations of RAG. These limitations include the recall problem of cosine similarity-based retrieval whereby certain concepts are either unknown to the embedding model (particularly relevant when working with embeddings generating from text written in lower-resource languages) or are a casualty of the chunking process. The limitations also include that RAG will struggle to find all the documents that are needed to give GPT-4 context, especially about events and concepts previously unseen by the LLM. To address the former limitation, the technical solution includes leveraging the micro and macro graph structures provided by the knowledge graph construction. The technical solution addresses the latter limitation by using the LLM's, such as GPT-4's reasoning abilities to efficiently traverse the graph structures and store the graph-curated set of relevant documents for the final generation.

A key limitation of a semantic search agent is that the only tool available to explore a dataset is to reformulate the user query and search again hoping for a different set of documents. The present novel graph-based LLM agent algorithms target this limitation by leveraging graph structures to explore the datasets in a more structured way. Pseudocode of an example graph-based LLM agent algorithm is detailed under Algorithm 1. Some of the key technical features provided by the algorithm are described below.

The example graph-based LLM agent algorithm starts with identifying candidate nodes (Vₑₙₜ∪V_{des}∪V_{ch nk}) from the developed graph G in three ways: entity extraction, cosine similarity over entity description embeddings, and document chunk embeddings. For purposes of explanation, the process implements ζ using the OpenAI “text-embedding ada-002” model. The process then uses GPT-4 to sample vi from this set of candidates using the entity names, their descriptions, and the user's ask/query. With vi chosen, the process uses an LLM, such as GPT-3.5-turbo to quickly filter out irrelevant documents, and finally add the remaining relevant documents to a notepad as a working list of documents. This process repeats the steps of fetching relevant documents from an entity by leveraging an LLM, such as GPT-4 to decide whether to resample a new entity, or whether to navigate to a new node in the node2vec graph embedding space. At the end of the exploration phase, the documents in the notepad are fed through carefully designed prompts to generate a response to the user ask u.

Algorithm 1 Graph Traversal Algorithm

Input: Graph G, user ask u, embedding model ζ, hyperparameters:
token limit τ, document retrieval limit D, max iterations T
Output: Response Text, answer

| | |
|---|---|
| 1: | Initialize i=0, notepad = [ ] |
| 2: | Compute the query embedding ζ(u). |
| 3: | Extract entities from u and return set of associated nodes in G |
| | as Vₑₙₜ. |
| 4: | Compute V_{des} and V_{chnk} as the sets of nodes in G closest to ζ(u) |
| | based on entity description embeddings and document chunk |
| | embeddings respectively. |
| 5: | Sample a node vᵢ from the candidate nodes: vᵢ = GPT − |
| | 4(Vₑₙₜ ∪ V_{des} U V_{chnk}). |
| 6: | Retrieve documents from vᵢ and use GPT-3.5-turbo to |
| | determine which are relevant |
| 7: | Add relevant documents to notepad. |
| 8: | while i < T and len(notepad) < D do |
| 9: | strategy = GPT-4(vᵢ, nearby entities) to determine |
| | exploration strategy. |
| 10: | if strategy is to find a new node then |
| 11: | REPEAT 3-7. |
| 12: | else |
| 13: | Set vᵢ₊₁ as the result of strategy. |
| 14: | REPEAT 6-7. |
| 15: | end if |
| 16: | i ← i + 1 |
| 17: | end while |
| 18: | answer = GPT-4(notepad, u) |

Creating quantitative experiments on RAG style results is a new space filled with technical challenges. Traditionally, conferences like IEEE VAST (IEEE Symposium on Visual Analytics Science and Technology) sought to evaluate the efficacy of intelligence systems, but the human synthesis portion of this evaluation was always qualitative, because the results were also always generated by humans. In the case of VAST, which is focused on intelligence analysis, they provide a challenge and then the output is a human written report which is compared to a human generated answer key, but this is a highly qualitative process. As technology provides a new future where machines start to perform reasoning in this space there is a great lack of labeled datasets.

Given this challenge, contrasting motivating examples show the potential of this research. These can be thought of as use cases with a clearly defined task and expected outcome-though a “correct outcome” or “incorrect outcome” may take a variety of forms due to the nuances of language. To this end, in addition to the discovery-based approaches to the UI driven community augmented RAG, below are some focused studies that evaluate specific aspects of the system as applied to the VIINA dataset. A knowledge graph system was deployed, traditional RAG, and a graph traversal RAG system, the latter two of which are compared side by side.

Some of the goals with graph traversal are to find significant background context about relevant entities (e.g., events, people, places, etc.) as many are unknown to the underlying LLM given the recency of the problem domains. Additionally, multi-hop reasoning questions are targeted over the dataset as whole. Given the complexity and conflicting sources present in the dataset, finding only one document about each entity will never generate an answer with sufficient depth and consideration of multiple perspectives. As such, one of the key pieces of this analysis is to determine if the present graph traversal can intelligently traverse the graph to discover a diverse set of entities and thus the necessary background context and perspectives.

FIGS. 10D-10F show additional UIs that continue to relate to the question introduced above “What is Novorossiya and what are its targets?”. FIG. 10G shows traditional standard semantic search results for comparison sake.

FIG. 10D relates to local graph structured semantic search. As used here ‘local’ graph structured semantic search involves a small number of traversal hops required to get from a source node to another node. FIG. 10D shows how the knowledge graph can be utilized to enable a local graph traversal based analytic to answer the question.

FIG. 10E relates to community structured semantic search. This FIG. shows how the knowledge graph can be utilized to enable a community graph traversal based analytic to answer the user question.

FIG. 10F relates to global structured semantic search. As used here ‘global’ graph structured semantic search involves overall structure of the knowledge graph-meaning the aggregated summarizations that have rolled up to form cohesive partitions. Using these partitions, aggregate summarization can be performed and questions answered from a perspective that accounts for the entire knowledge graph. FIG. 10F shows how the knowledge graph can be utilized to enable a global graph traversal based analytic to answer the question. These UIs include check boxes or other selection mechanisms through which the user can select and trace the providence of the content through the graph traversal process.

FIG. 11 shows another example that involves the question “Based on the Black Sea grain deal, are there any indications that Russia will strike non-Ukrainian commercial ships inbound for Ukrainian ports?”. This question targets events that started to unfold in June 2023, past the knowledge cutoff of GPT-4. As such, it is necessary to retrieve source documents about a myriad of entities required to answer the question effectively: news about the grain deal expiring soon, previous events that support a conclusion, and even context about the current state of the conflict. Observing the traversal, shows that this traversal hits on many of the entities required to generate a holistic answer. The traversal begins by sampling nodes around the grain deal itself (Black Sea Grain Initiative, Joint Coordination Center), then the naval fleets in the area (Sea Trawlers Chernigov, Ukraine Navy, Black Sea Fleet), previous attacks and conflict in the area (Attack on Black Sea, Attack on Odessa), and finally context about diplomatic actions being taken (Istanbul, Russia-UN Memorandum). Furthermore, this translates to a response which has the latest context on the grain deal and covers both Russian and Ukrainian stances. FIG. 11 shows that the graph traversal was able to discover four broad categories of entries: Black Sea Grain Deal, Naval fleets, previous attacks in the area, and diplomats and diplomatic events.

FIG. 12 shows another example that relates to analyzing the traversal for the multi-hop question “What is the current status of Nikopolshachyna. Is there any aid that has been received?”. This example shows the power of the graph traversal to disambiguate between duplicate entities. Despite the previously described entity resolution step, it is still not completely eliminated in the graph due to the challenge in disambiguating entities from lower-resource language also not prevalent in the model's training. For example, the traversal begins with getting context about the region and its mayor (Serhiy Lysak) while traversing to both entities which may contain different source documents (Nikopol District, Nikopol and Sergiy Lisak, Sergey Lisak). The traversal also retrieves an entity specifically tailored towards aid (Sending Help) and finally finds the entities related to the Kakhovka Dam, which are critical to getting the recent event context needed to answer the question. FIG. 12 shows that the traversal was able to get context about the area (Nikopol and its governor, Serhiy Lisak), details about aid, and finally context about the event that happened in and around the power station.

The description now turns to comparing results using the documents retrieved by RAG in comparison to those found by the current graph traversal concepts. Note that, final responses from each method are generated in the same way: model and prompt construction, the only difference being the source documents provided. In both cases, documents were truncated such that at least the first 450 tokens of all source documents fit within the context window.

FIGS. 8A-8C are introduced above and show analysis of the question “This dataset covers all news from June. Given this, what thematic events are of most importance to review?”. RAG performs a nearest neighbors search on the question, which as shown by the response is very unlikely to produce all the useful information as the question is asking for aggregated summaries. Instead, it tends to pull a random assortment of data into the context window, which it then summarizes. This is a summarization task for which the RAG has no context, so the expectation is that it ultimately sampled a bunch of somewhat random documents and then summarized them. In contrast, the current graph-based approach can make use of the knowledge graph structure to discover various distinct and more important topics of interest. This gives it a fuller context and results in a far more comprehensive outcome, which has the benefit of being grounded on activities observed across the entire dataset.

As introduced above, FIGS. 8A-8C show that the graph traversal was able to retrieve context about more relevant events and broad topics of interest: The Kakhovka Dam (which both methods retrieve), but the graph traversal also provides details about its humanitarian impact, the Ukrainian counteroffensive, the Russian perspective on the counteroffensive, and attacks on Kyiv and Lviv.

As mentioned above, FIGS. 10A-10G show another comparison. FIG. 10A is a shortened version of the content of FIGS. 10B and 10C that better fits on the drawing page. This comparison relates to the question “What is novorossiya and what are its targets?”. As shown on FIGS. 10A and 10C, the graph-based LLM agent's traversal allows it to formulate a deeper understanding of the source documents and reach similar nodes, gathering very specific information about events that happened in Odessa with respect to Novorossiya. The novel process again automatically discovers and augments the knowledge graph's result by navigating between two semantically equivalent entities: novorossiya and Novorosiya, both of which refer to New Russia. Mapping to the result, shows how the graph traversal entails a technical solution that is able to provide two distinct perspectives on a relatively ambiguous question in the physical and ideological targets of Novorossiya.

In contrast, as shown on FIG. 10B the RAG response completely misses the mark by discussing literal targets of the Ukrainian army. Another indicator of success here, is that the graph traversal response cites almost every source provided to it, while the RAG response only cites the sources, indicating a lack of relevancy in the retrieved documents. Note that these are different sources. For RAG, the source is a chunk of a text document, which can be quite large. For the present techniques, the source is a meaningful summary (entity, relationship, claim, community) that summarizes multiple text chunks and enables semantic references (e.g., to entity 5). In summary, the graph traversal agent is able to explore the knowledge graph to gather a more holistic set of direct source documents, allowing for a) a significantly more grounded answer, b) a response that considers more perspectives and sources, and c) is able to gather substantial context on events, people, concepts, etc. that were not seen during training.

FIG. 10C shows graph traversal and cites both Ukrainian and Russian perspectives, and mentions a specific example in Odessa of a targeted attack as being one of the examples of “targets” of Novorossiya. This can be attributed to all the retrieved documents and references from the Russian news source ria, whereas graph traversal retrieves a diverse set (from three sources).

FIG. 10D shows results associated with a local structured semantic search relating to the same question presented in FIGS. 10A-10C, namely “what is Novorossiya and what are its targets?”. For sake of comparison, FIG. 10E shows results associated with a community structured semantic search relating to the same question.

FIGS. 10F and 10G show a side-by-side comparison of global structured semantic search and traditional RAG. In this case, the user question is “What are the top 5 themes in the data?”. FIG. 10G shows the results for traditional RAG and FIG. 10F shows the results for global structured semantic search. Traditional RAG provides meaningless or erroneous results (e.g., the themes are wrong). In contrast, global structured semantic search provides meaningful and accurate theme results.

FIGS. 11 and 12 show two additional examples of the results that can be provided by graph traversal. FIG. 11 relates to a user question regarding “Based on the Black Sea grain deal, are there any indications that Russia will strike non-Ukrainian commercial ships inbound for Ukrainian ports?”. RAG could not answer this question but graph traversal provides a meaningful answer with citations. The response also includes the graph traversal path to aid the reader in understanding how the information was obtained. Similarly, FIG. 12 relates to a user question regarding “What is the current status of Nikopolshachyna. Is there any aid that has been received?”. Again the response contains valuable information that RAG could not provide. The response includes citations and the graph traversal path to aid the user in understanding the investigative process.

Examples are described relative to a specific dataset. The same techniques can be applied to different dataset sizes, all of which are unseen by the model's training data as they are private information from internal companies or were produced after the model was trained. Similarly, while specific LLMs were used in these examples, the present concepts are applicable to other LLMs and more generally to other GAI models.

Responsible AI (RAI) is considered with the present concepts. Two potentially key areas of considerations within RAI that are important when evaluating or using the results from the present knowledge graph and agent traversal framework include hallucinations during graph induction and the lack of quantitative metrics to assess knowledge graph assisted generation.

Graph induction hallucinations generated by the LLM are known to show up even when grounded using RAG techniques. These LLM hallucinations only emerge at generation time and do not occur while performing vector search for relevant content, forming a fundamental separation between RAG-based hallucinations and graph-based hallucinations that may occur. The utilization of the LLM to induce the knowledge graph itself opens the door to dual-layer hallucinations where the LLM can falsely infer links between entities in the knowledge graph that are connected when they are not. In consideration of the possible harms, an inaccurate knowledge graph may inadvertently be created due to hallucinatory entity resolution (e.g., thinking two people are the same and therefore providing wrong information about them). By using a falsely inferred relationship generated by the LLM and further grounding on the knowledge graph during generation time, the LLM makes a dual-reinforced hallucination that establish bogus relations.

This description of the present concepts shows the ability to break through some key limitations of RAG, an approach to grounding LLM responses that is being widely used in practice. The technical solution involves two novel techniques for utilizing the LLM's capabilities to surpass RAG's failures and curating a new internally available dataset. Graph-based LLM agents are able to collect a comprehensive set of grounding data for response generation through consideration of broader sources and perspectives. In the described case examples, the response quality of graph-based LLM agents over RAG in aggregate reasoning is evident-a meaningful contribution to advance the state-of-the-art in terms of analytic depth and groundedness. Note that this increase in response quality currently comes at increased total system LLM token usage (and thus cost and latency) as compared to a standard RAG system.

FIGS. 13-16 show example alternative and/or complementary algorithms to example Algorithm 1 described above.

FIG. 13 shows an example flow chart or method 1300 for classifying the user query and dynamically selecting an appropriate method for generating the response. Beginning with a user query at 1302, the method performs question type assessment on the query at 1304. The method then determines whether the question requires summarizations of the whole dataset at 1306. If summarizations of the whole dataset are required (e.g., yes at 1306), the method progresses to knowledge graph RAG with global summarization at 1308.

If summarizations of the whole dataset are not required (e.g., no at 1306), the method progresses to determine whether the question is related to a particular/specific entity at 1310. If the question relates to a particular entity (e.g., yes at 1310), the method progresses to knowledge graph RAG with local summarization at 1312.

If the question does not relate to a particular entity (e.g., no at 1310), the method progresses to knowledge graph RAG with community summarization at 1314.

FIG. 14 shows a flowchart or method 1400 relating to local summarization. The method relates to entity text embeddings 1402, entity graph embeddings 1404, knowledge graphs 1406 (e.g., introduced above as knowledge graphs 106), entity covariates 1408, and/or other entity aspects. This method is best suited for answering user questions or queries 1302 related to specific entities that have a small number of related entities. An example of such a query is “What is Novorossiya and what are its targets?”. The first step of the method involves query-entity mapping at 1412. This step involves extracting top-N graph entities that have the highest semantic relevance to the user query by computing the similarity score between the text embeddings of the user query and the entity description.

The next step of the method involves related entity extraction at 1414. For each target entity E extracted from step 1412, the method finds the top-K neighbors with the highest behavioral relevance. This can be computed as the similarity score of the graph embeddings of E and other entities in the graph, or as the degree of the direct connections of E.

The next step of the method involves entity relationship and covariate retrieval at 1416. Given the entity set extracted from steps 1412 and 1414, the method retrieves all covariates associated with these entities (e.g., claims), and all records of relationships between these entities. This data is used to construct the context for answering the user query.

The next step of the method involves response generation at 1418. Given the user query and the data context constructed in step 1416, the method uses a generative AI model to generate a final response 1420. The final response 1420 can be an example of the comprehensive response 110 introduced relative to FIG. 1. An example local structured semantic search final response is shown in FIG. 10D.

FIG. 15 shows a flowchart or method 1500 relating to community relationships or summarization. This method relates to the entity text embeddings 1402 and entity graph embeddings 1404 introduced above as well as community summaries/full reports 1502, and community text embedding 1504, among others. This method is best suited for answering questions related to specific communities, or general entities associated with large communities. An example query is “How are the relationships of Russia with other countries?”.

Starting with a user query 1302, the first step of the method involves related community extraction at 1506. The method can identify communities that are related to the user query using one or more of the following sub-methods involving entity extraction, text embedding, and/or generative AI-based entity extraction. Entity extraction sub-methods involve extracting entities related to the user query using steps 1412 and 1414 of the Local RAG method of FIG. 14 and returns a set of communities that contain these entities.

Text embedding-based sub-methods compute the semantic similarity score between the text embeddings of the user query and the summary or full report of each community, and return the top-N communities with the highest scores.

Generative AI-based sub-methods ask the generative AI model to return a subset of communities that are relevant to the user query and community summaries.

The next step of the method involves response generation at 1508. This method step involves concatenating the full reports of the related communities to form a data context for the generative AI model to produce the final response 1510. The final response 1510 can be an example of the comprehensive response 110 introduced relative to FIG. 1. An example community structured semantic search final response is shown in FIG. 10E. If the data context exceeds the maximum length limit of the model, the method uses the map-reduce algorithm to split and merge answers as described in the Global RAG method.

FIG. 16 shows a flow chart or method relating to global knowledge graph RAG. This method utilizes community full reports 1602, which may be similar or identical to the community summaries/full reports 1502 of FIG. 15. This method is best suited for answering questions that require summarization of the dataset as a whole. An example question discussed above relative to FIG. 10F is “What are the five most important thematic events to review in this dataset?” or “What are the top 5 themes in the data?”.

Starting with a user query 1302, the first step of the method involves intermediate response generation and ranking at step 1604. The method step can shuffle and partition all community reports into N non-overlapping chunks, such that each chunk can be accommodated within a fixed-size context window. For each of the N chunks, the method uses a generative AI model to generate a response to the user question, along with a numerical score that indicates the quality of the answer. The method ranks the answers by the quality score and discards any answer with a score below a predefined threshold.

The next step of the method involves intermediate response combination at 1606. The step combines the ranked intermediate responses from step 1604 into a single context window and uses a generative AI model to produce final response 1608. The final response 1608 can be an example of the comprehensive response 110 introduced relative to FIG. 1. An example global structured semantic search final response is shown in FIG. 10F.

FIGS. 17 and 18 relate to additional novel methods.

FIG. 17 shows a novel method 1700. At block 1702 the method can supply a dataset to a generative artificial intelligence (GAI) model for purposes of indexing and generating a knowledge graph relating to the dataset.

At block 1704 the method can generate aggregated summaries over the knowledge graph. For instance, this can entail running graph machine learning on the knowledge graph to extract semantic summaries from the knowledge graph. This process can also be applied to other aggregated operations beyond or in place of aggregated summaries.

FIG. 18 shows a novel method 1800. At block 1802 the method can obtain aggregated summaries and a related knowledge graph.

At block 1804 the method can enable local, community, and global retrieval augmented generation utilizing the aggregated summaries and the knowledge graph.

The order in which the disclosed methods are described is not intended to be construed as a limitation, and any number of the described acts can be combined in any order to implement the method, or an alternate method. Furthermore, the methods can be implemented in any suitable hardware, software, firmware, or combination thereof, such that a computing device can implement the method. In one case, the methods are stored on one or more computer-readable storage medium/media as a set of instructions such that execution by a processor of a computing device causes the computing device to perform the method.

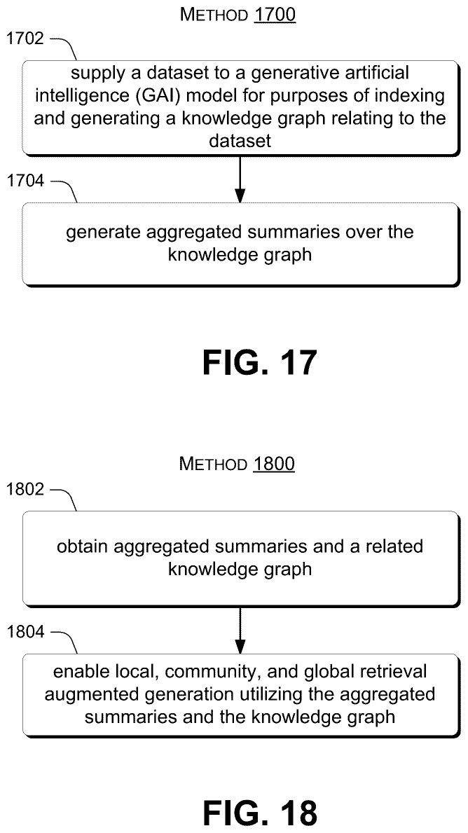

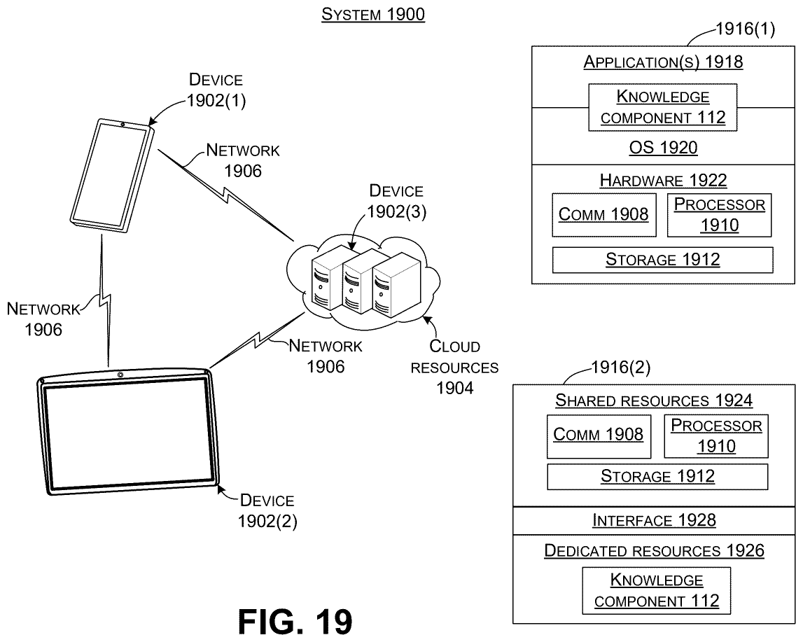

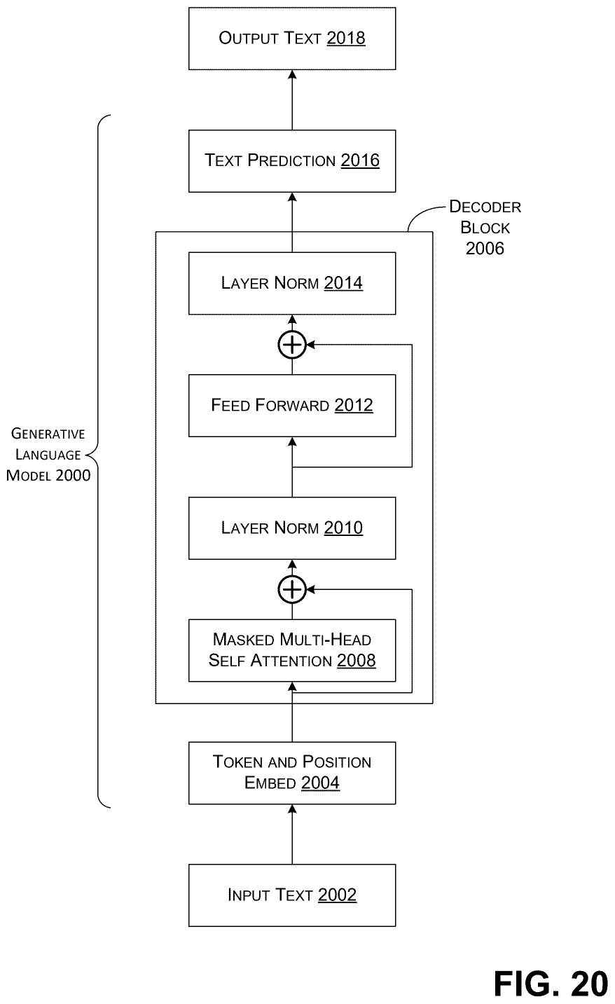

FIG. 19 shows an example system 1900. System 1900 can include computing devices 1902. In the illustrated configuration, computing device 1902(1) is manifest as a smartphone, computing device 1902(2) is manifest as a tablet type device, and computing device 1902(3) is manifest as a server type computing device, such as may be found in a datacenter as a cloud resource 1904. Computing devices 1902 can be coupled via one or more networks 1906 that are represented by lightning bolts. In some cases, some of the computing devices 1902 can function as edge devices between other computing devices.

Computing devices 1902 can include a communication component 1908, a processor 1910, storage resources (e.g., storage) 1912, and/or knowledge component 112. The knowledge component 112 can be implemented as an application, framework, and/or service. The knowledge component 112 can be implemented locally (e.g., on a user's device), on an edge device, or remotely, such as in the cloud. The knowledge component 112 interacts with GAI models. The GAI models may be on the same device as the knowledge component 112 or a different device. For example, the GAI models can be implemented locally (e.g., on a user's device), on an edge device, or remotely, such as in the cloud.

Knowledge component 112 can supply a dataset to a generative artificial intelligence (GAI) model for purposes of indexing and generating a knowledge graph relating to the dataset and can generate aggregated summaries over the knowledge graph. Knowledge component 112 can obtain aggregated summaries and the associated knowledge graph and enable local, community, and global retrieval augmented generation utilizing the aggregated summaries and the knowledge graph. Toward this end, the knowledge component 112 can generate user interfaces (UIs). The UIs can be configured to present information to the user and/or receive information from the user. For instance, a UI could allow a user to specify a dataset. The knowledge component 112 could interact with the GAI, such as an LLM to create the knowledge graph, indexing, and/or aggregated summaries. The knowledge component 112 can generate additional UIs that allow the user to obtain more meaningful information relative to the dataset than was previously possible. Examples are described above. Further, the knowledge component can increase computer efficiency (e.g., processor efficiency) by providing a useful answer to the user query for a given set of processor operations and reducing the need for follow up queries (and associated processor operations) to obtain the desired information.

FIG. 19 shows two device configurations 1916 that can be employed by computing devices 1902. Individual computing devices 1902 can employ either of configurations 1916(1) or 1916(2), or an alternate configuration. (Due to space constraints on the drawing page, one instance of each configuration is illustrated). Briefly, device configuration 1916(1) represents an operating system (OS) centric configuration. Device configuration 1916(2) represents a system on a chip (SOC) configuration. Device configuration 1916(1) is organized into one or more applications 1918, operating system 1920, and hardware 1922. Device configuration 1916(2) is organized into shared resources 1924, dedicated resources 1926, and an interface 1928 therebetween.

In configuration 1916(1), the knowledge component 112 can be manifest as part of the operating system 1920. Alternatively, the knowledge component 112 can be manifest as part of the applications 1918 that operate in conjunction with the operating system 1920 and/or processor 1910. In configuration 1916(2), the knowledge component 112 can be manifest as part of the processor 1910 or a dedicated resource 1926 that operates cooperatively with the processor 1910.

In some configurations, each of computing devices 1902 can have an instance of the knowledge component 112. However, the functionalities that can be performed by the knowledge component 112 may be the same or they may be different from one another when comparing computing devices. For instance, in some cases, each prediction manager knowledge component 112 can be robust and provide all of the functionality described above and below (e.g., a device-centric implementation).

In other cases, some devices can employ a less robust instance of the knowledge component 112 that relies on some functionality to be performed by another device.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, device configuration 1916(2) can be thought of as a system on a chip (SOC) type design. In such a case, functionality provided by the device can be integrated on a single SOC or multiple coupled SOCs. One or more processors 1910 can be configured to coordinate with shared resources 1924, such as storage 1912, etc., and/or one or more dedicated resources 1926, such as hardware blocks configured to perform certain specific functionality. Thus, the term “processor” as used herein can also refer to central processing units (CPUs), graphical processing units (GPUs), neural processing units (NPUs), field programmable gate arrays (FPGAs), controllers, microcontrollers, processor cores, hardware processing units, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU, CPUs, GPU or GPUs). The program code can be stored in one or more computer-readable memory devices, such as computer-readable storage media. The features and techniques of the components are platform-independent, meaning that they may be implemented on a variety of commercial computing platforms having a variety of processing configurations.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

For the purposes of this document, the term “language model” refers to any type of automated agent that communicates via natural language. For instance, a language model can be implemented as a neural network, e.g., a decoder-based generative language model such as ChatGPT, a long short-term memory model, etc. The term “generative model,” as used herein, refers to a machine learning model employed to generate new content. Generative models can be trained to predict items in sequences of training data. When employed in inference mode, the output of a generative model can include new sequences of items that the model generates. Thus, a “generative language model” is a model that can generate new sequences of text given some input prompt, e.g., a query potentially with some additional context.

The term “prompt,” as used herein, refers to input text provided to a generative language model that the generative language model uses to generate output text. A prompt can include a query, e.g., a request for information from the generative language model. A prompt can also include context, or additional information that the generative language model uses to respond to the query.

The term “data health issue” refers to any characteristic of a dataset that could impact results of processing that dataset. Examples of data health issues include the presence of corrupted data, erroneous data, improperly formatted data, statistical outliers, etc. The term “data evaluation action” refers to any action performed on a dataset that can identify a data health issue. A “data evaluation plan” is one or more data evaluation actions that can be performed on a given dataset. A “data cleaning action” is an action that attempts to improve data quality by correcting at least one data health issue, e.g., by removing an entry or value from a dataset, changing a value in the dataset to a different value, etc.

A “summary” of a dataset refers to a representation of the dataset as a whole. A summary of a dataset can include data types of fields of the dataset, statistical information for fields of the dataset, and/or annotations of individual fields of the dataset, a set of fields of the dataset, or the dataset as a whole. A “data health score” refers to any metric that characterizes the presence of data health issues in a dataset. A “severity dictionary” is one or more indications of how severe a particular type of data health issue is when present in a dataset. For instance, a severity dictionary can indicate that missing values are relatively more severe than statistical outliers, and can include weights designating the relative severity of each.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards. The term “user-specific model” refers to a model that has at least one component that has been trained or constructed at least partially for a specific user. Thus, this term encompasses models that have been trained entirely for a specific user, models that are initialized using multi-user data and tuned to the specific user, and models that have both generic components trained for multiple users and one or more components trained or tuned for the specific user. Likewise, the term “application-specific model” refers to a model that has at least one component that has been trained or constructed at least partially for a specific application.

The term “pruning” refers to removing parts of a machine learning model while retaining other parts of the machine learning model. For instance, a large machine learning model can be pruned to a smaller machine learning model for a specific task by retaining weights and/or nodes that significantly contribute to the ability of that model to perform a specific task, while removing other weights or nodes that do not significantly contribute to the ability of that model to perform that specific task. A large machine learning model can be distilled into a smaller machine learning model for a specific task by training the smaller machine learning model to approximate the output distribution of the large machine learning model for a task-specific dataset.

### Example Decoder-Based Language Model

FIG. 20 illustrates an example GAI model, such as generative language model 2000 that can be employed using the disclosed implementations. Generative language model 2000 is an example of a machine learning model that can be used to perform one or more natural language processing tasks that involve generating text, as discussed more below. For the purposes of this document, the term “natural language” means language that is normally used by human beings for writing or conversation.

Generative language model 2000 can receive input text 2002, e.g., a prompt from a user. For instance, the input text can include words, sentences, phrases, or other representations of language. The input text can be broken into tokens and mapped to token and position embeddings 2004 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 2004 are processed in one or more decoder blocks 2006. Each decoder block implements masked multi-head self-attention 2008, which is a mechanism relating different positions of tokens within the input text to compute the similarities between those tokens. Each token embedding is represented as a weighted sum of other tokens in the input text. Attention is only applied for already-decoded values, and future values are masked. Layer normalization 2010 normalizes features to mean values of 0 and variance to 1, resulting in smooth gradients. Feed forward layer 2012 transforms these features into a representation suitable for the next iteration of decoding, after which another layer normalization 2014 is applied. Multiple instances of decoder blocks can operate sequentially on input text, with each subsequent decoder block operating on the output of a preceding decoder block. After the final decoding block, text prediction layer 2016 can predict the next word in the sequence, which is output as output text 2018 in response to the input text 2002 and also fed back into the language model. The output text can be a newly-generated response to the prompt provided as input text to the generative language model.

Various examples are described above. Additional examples are described below. One example includes a method comprising obtaining aggregated summaries and a related knowledge graph and enabling local, community, and global retrieval augmented generation utilizing the aggregated summaries and the knowledge graph.

Another example can include any of the above and/or below examples where the method further comprises aggregating edges between shared nodes and using frequency count as an edge weight of the knowledge graph.

Another example can include any of the above and/or below examples where the method further comprises iteratively removing high degree nodes to improve modularity of the knowledge graph.

Another example can include any of the above and/or below examples and further comprising creating a representation of individual points that are associated with individual nodes.

Another example can include any of the above and/or below examples and further comprising transforming data of the knowledge graph from a high-dimensional space into a low-dimensional space.

Another example can include any of the above and/or below examples and further comprising identifying individual unique entities associated with an individual node.

Another example can include any of the above and/or below examples and further comprising applying a hierarchical clustering algorithm that recursively merges community sub-graphs into node pairs.

Another example can include any of the above and/or below examples and further comprising applying multiple pre-aggregation steps to the knowledge graph that leverage the community sub-graphs.

Another example can include a system comprising storage configured to store computer-readable instructions, and a processor configured to execute the computer-readable instructions to obtain aggregated operations and a related knowledge graph, and enable graph-based retrieval augmented generation utilizing the aggregated operations and the knowledge graph.

Another example can include any of the above and/or below examples where the processor is configured to accomplish the enabling graph-based retrieval augmented generation by aggregate edges of the knowledge graph between nodes and using frequency count as an edge weight, iteratively remove high degree nodes until modularity improves and network diameter expands, create a representation of which points are associated with which nodes, transform data from a high-dimensional space into a low-dimensional space, identify partitions of nodes into communities, determine node size based in part on the identified partitions of nodes, apply a hierarchical clustering algorithm that recursively merges community sub-graphs into node pairs, and apply multiple pre-aggregation steps to the knowledge graph that leverage the community sub-graphs.

Another example can include a computer-readable storage medium storing instructions comprising performing question assessment on a user query relating to a private dataset, determining whether the user query requires summarizations of an entirety (whole) of the whole dataset, in instances where the user query requires summarizations of the entirety of the dataset, processing the user query utilizing knowledge graph retrieval augmented generation (RAG) with global summarization, in instances where the user query does not require summarizations of the entirety of the dataset, evaluating whether the user query relates to a particular entity of the private dataset, in instances where the question relates to a particular entity of the private dataset, processing the user query utilizing knowledge graph RAG with local summarization, and in instances where the user query does not relate to a particular entity of the private dataset, processing the user query utilizing knowledge graph RAG with community summarization.

Another example can include any of the above and/or below examples where the computer-readable storage medium further comprises causing a user-interface to be generated that is configured to receive the user query.

Another example can include any of the above and/or below examples where the computer-readable storage medium further comprises causing the user-interface to be generated to present information relating to the knowledge graph RAG with global knowledge graph RAG with traversal based summarization, or knowledge graph RAG with community summarization.

Another example can include any of the above and/or below examples where the computer-readable storage medium further comprises causing the user-interface to allow user input to select specific information from the presented information for further processing.

Another example can include any of the above and/or below examples where processing the user query with knowledge graph RAG with global summarization comprises shuffling and partitioning all community reports into a number of non-overlapping chunks that are less than a maximum fixed-size context window, and for each chunk causing a generative artificial intelligence model to generate intermediate responses to the user query that include a numerical score that indicates quality of the generated intermediate responses and rankings of the generated intermediate responses.

Another example can include any of the above and/or below examples where processing the user query with knowledge graph RAG with global summarization comprises combining the ranked intermediate responses into a single context window and using a generative AI model to produce a final response.

Another example can include any of the above and/or below examples where processing the user query utilizing knowledge graph RAG with local summarization comprises extracting graph entities that have high semantic relevance to the user query by computing similarity scores between text embeddings of the user query and entity descriptions.

Another example can include any of the above and/or below examples where the computer-readable storage medium further comprises finding entity neighbors with high behavioral relevance.

Another example can include any of the above and/or below examples where the computer-readable storage medium further comprises retrieving covariates associated with the entities having high semantic relevance and the entity neighbors with high behavioral relevance and recording relationships between these entities.

Another example can include any of the above and/or below examples where generating a final response to the user query based at least in part on the covariates associated with the entities having high semantic relevance and the entity neighbors with high behavioral relevance and the recorded relationships between these entities.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
obtaining aggregated summaries and a related knowledge graph; and,
enabling local, community, and global retrieval augmented generation utilizing the aggregated summaries and the knowledge graph.

2. The method of claim 1, further comprising aggregating edges between shared nodes and using frequency count as an edge weight of the knowledge graph.

3. The method of claim 2, further comprising iteratively removing high degree nodes to improve modularity of the knowledge graph.

4. The method of claim 3, further comprising creating a representation of individual points that are associated with individual nodes.

5. The method of claim 4, further comprising transforming data of the knowledge graph from a high-dimensional space into a low-dimensional space.

6. The method of claim 5, further comprising identifying individual unique entities associated with an individual node.

7. The method of claim 6, further comprising applying a hierarchical clustering algorithm that recursively merges community sub-graphs into node pairs.

8. The method of claim 7, further comprising applying multiple pre-aggregation steps to the knowledge graph that leverage the community sub-graphs.

9. A system, comprising:
storage configured to store computer-readable instructions; and,
a processor configured to execute the computer-readable instructions to:
obtain aggregated operations and a related knowledge graph; and,
enable graph-based retrieval augmented generation utilizing the aggregated operations and the knowledge graph.

10. The system of claim 9, wherein the processor is configured to accomplish the enabling graph-based retrieval augmented generation by:
aggregate edges of the knowledge graph between nodes and use frequency count as an edge weight;
iteratively remove high degree nodes until modularity improves and network diameter expands;
create a representation of which points are associated with which nodes;
transform data from a high-dimensional space into a low-dimensional space;
identify partitions of nodes into communities;
determine node size based in part on the identified partitions of nodes;
apply a hierarchical clustering algorithm that recursively merges community sub-graphs into node pairs; and,
apply multiple pre-aggregation steps to the knowledge graph that leverage the community sub-graphs.

11. A computer-readable storage medium storing instructions comprising:
performing question assessment on a user query relating to a private dataset;
determining whether the user query requires summarizations of an entirety of the private dataset;
in instances where the user query requires summarizations of the entirety of the private dataset, processing the user query utilizing knowledge graph retrieval augmented generation (RAG) with global summarization;
in instances where the user query does not require summarizations of the entirety of the private dataset, evaluating whether the user query relates to a particular entity of the private dataset;
in instances where the question relates to a particular entity of the private dataset, processing the user query utilizing knowledge graph RAG with local summarization; and,
in instances where the user query does not relate to a particular entity of the private dataset, processing the user query utilizing knowledge graph RAG with community summarization.

12. The computer-readable storage medium of claim 11, further comprising causing a user-interface to be generated that is configured to receive the user query.

13. The computer-readable storage medium of claim 12, further comprising causing the user-interface to be generated to present information relating to the knowledge graph RAG with global knowledge graph RAG with traversal based summarization, or knowledge graph RAG with community summarization.

14. The computer-readable storage medium of claim 13, further comprising causing the user-interface to allow user input to select specific information from the presented information for further processing.

15. The computer-readable storage medium of claim 11, wherein processing the user query with knowledge graph RAG with global summarization comprises shuffling and partitioning all community reports into a number of non-overlapping chunks that are less than a maximum fixed-size context window, and for each chunk causing a generative artificial intelligence model to generate intermediate responses to the user query that include a numerical score that indicates quality of the generated intermediate responses and rankings of the generated intermediate responses.

16. The computer-readable storage medium of claim 15, wherein processing the user query with knowledge graph RAG with global summarization comprises combining the ranked intermediate responses into a single context window and using the generative artificial intelligence model to produce a final response.

17. The computer-readable storage medium of claim 11, wherein processing the user query utilizing knowledge graph RAG with local summarization comprises extracting graph entities that have high semantic relevance to the user query by computing similarity scores between text embeddings of the user query and entity descriptions.

18. The computer-readable storage medium of claim 17, further comprising finding entity neighbors with high behavioral relevance.

19. The computer-readable storage medium of claim 18, further comprising retrieving covariates associated with the entities having high semantic relevance and the entity neighbors with high behavioral relevance and recording relationships between these entities.

20. The computer-readable storage medium of claim 19, further comprising generating a final response to the user query based at least in part on the covariates associated with the entities having high semantic relevance and the entity neighbors with high behavioral relevance and the recorded relationships between these entities.
